(19) United States
(12) Patent Application Publication
(10) Pub. No.: US 2009/0096828 A1
(43) Pub. Date: Apr. 16, 2009

(54) Liquid ejecting apparatus and method for moving medium

(75) Inventors: Michiaki Tokunaga, Matsumoto-shi (JP); Masahiko Yoshida, Shiojiri-shi (JP); Takeshi Yoshida, Nagano-ken (JP); Tatsuya Nakano, Hata-machi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/283,673

(22) Filed: Sep. 15, 2008

(30) Foreign Application Priority Data
Sep. 14, 2007 (JP) 2007-240062

(51) Int. Cl. B41J 29/38

(52) U.S. Cl. 347/16

(57) ABSTRACT

A liquid ejecting apparatus includes an upstream-side roller and an downstream-side roller, an ejecting section, and a controller. The controller stores in advance a correction value for correcting a pre-correction target transport amount for transporting the medium, the correction value being associated with a range from a first position to a second position. The controller carries out the transport operation based on a post-correction target transport amount in the case where the controller carries out the transport operation in such a manner as the medium is transported from a third position upstream in the transport direction from the second position to a fourth position downstream in the transport direction from the first position and the third position, the post-correction target transport amount being obtained by correcting, using the correction value, the pre-correction target transport amount for transporting the medium from the third position to the fourth position.

### CROSS-REFERENCE TO RELATED APPLICATION

The present application claims priority upon Japanese Patent Application No. 2007-240062 filed on Sep. 14, 2007, which is herein incorporated by reference.

### BACKGROUND

1. Technical Field

The present invention relates to a liquid ejecting apparatus and a method for moving a medium.

2. Related Art

Liquid ejecting apparatuses, such as inkjet printers, that eject liquid to a medium (paper, cloth, OHP sheet, etc.) while transporting the medium in a transport direction have already been known. In order to transport the medium, the liquid ejecting apparatuses have transport rollers provided respectively on the upstream side and the downstream side in the transport direction. The transport rollers each transport the medium by rotating while the medium being sandwiched therewith. In the liquid ejecting apparatuses, a transport operation by the transport rollers and a liquid ejection operation are carried out repeatedly in an alternating manner.

Moreover, as a method of properly transporting the medium in the liquid ejecting apparatuses, a method is known in which a correction value is obtained in order to correct a target transport amount for transporting the medium and the transport rollers carry out the transport operation based on an aimed transport amount that has been corrected using the correction value (see JP-A-5-96796).

Incidentally, when the medium continues to be transported in the transport direction, the medium is initially sandwiched with both of the transport roller on the upstream side and the transport roller on the downstream side, and then an end (rear end) of the medium on the upstream side in the transport direction comes off the transport roller on the upstream side and the medium is no longer sandwiched with the transport roller on the upstream side. At this time, a sandwiching pressure by the transport roller on the upstream side unnecessarily acts on the medium. This causes a transport error (hereinafter, this phenomenon is referred to as “kicking-off”). In order to properly transport the medium by giving consideration to the transport error due to kicking-off, it is necessary to obtain a correction value corresponding to the transport error due to kicking-off. Moreover, this correction value is associated with a range from a first position to a second position, the first position being a position where the medium is located in the transport direction when the medium is sandwiched with both of the upstream-side transport roller and the downstream-side transport roller, the second position being a position where the medium is located in the transport direction while the medium is sandwiched with only the downstream-side transport roller of the both transport rollers. Then, in the case where a movement range of the medium in a certain transport operation overlaps with the above-described range, the correction value is applied to the certain transport operation. That is to say, when carrying out a transport operation that transports the medium from a third position upstream in the transport direction from the second position to a fourth position downstream in the transport direction from the first position, the target transport amount for transporting the medium from the third position to the fourth position is corrected using the correction value, and the transport operation is carried out based on the corrected target transport amount.

Incidentally, the correction value should essentially be applied to a transport operation that transports the medium in such a manner as the medium passes through a position (hereinafter referred to as the “kicking-off occurring position”) where the medium is located in the transport direction at the time of occurrence of kicking-off. However, when the correction value is applied as described above, there is the possibility that the correction value is also applied to a transport operation to which the correction value should not be applied. That is to say, in the above-described situations, the correction value is applied to any transport operation that transports the medium from the third position to the fourth position even when the kicking-off occurring position is not positioned between the third position and the fourth position. In such a case, the correction value corresponding to the transport error due to kicking-off improperly exerted the correction effect, and in addition thereto, it is difficult to properly transport the medium.

### SUMMARY

The invention was arrived at in view of the foregoing matters, and it is an advantage of an aspect thereof to properly carry out the transport operation that transports the medium.

A primary aspect of the invention is a liquid ejecting apparatus such as the following.

A liquid ejecting apparatus including:

an upstream-side transport roller and a downstream-side transport roller that are respectively provided on an upstream side and a downstream side in a transport direction of a medium, and that transport the medium by rotating while the medium being sandwiched therewith;

an ejecting section that ejects liquid to the medium; and

a controller

that carries out repeatedly, in an alternating manner, a transport operation of the medium by at least either one of the upstream-side transport roller and the downstream-side transport roller and an ejection operation of the liquid by the ejecting section;

that stores in advance a correction value for correcting a pre-correction target transport amount for transporting the medium, the correction value being associated with a range from a first position where the medium is located in the transport direction when the medium is sandwiched with both of the upstream-side transport roller and the downstream-side transport roller to a second position where the medium is located in the transport direction when the medium is sandwiched with only the downstream-side transport roller of both transport rollers;

that carries out the transport operation based on a post-correction target transport amount in the case where the controller carries out the transport operation in which the medium is transported from a third position upstream in the transport direction from the second position to a fourth position downstream in the transport direction from the first position and the third position, the post-correction target transport amount being obtained by correcting, using the correction value, the pre-correction target transport amount for transporting the medium from the third position to the fourth position; and

that carries out the transport operation in which the medium is transported from a position upstream in the transport direction from the first position to a position downstream in the transport direction from the second position, as the transport operation in which the medium is transported from the third position to the fourth position.

Other features of the invention will become clear through the accompanying drawings and the following description.

### BRIEF DESCRIPTION OF THE DRAWINGS

For a more complete understanding of the invention and the advantages thereof, reference is now made to the following description taken in conjunction with the accompanying drawings.

FIG. 1 is a block diagram of the overall configuration of a printer 1.

FIG. 2A is a schematic view of the overall configuration of the printer 1.

FIG. 2B is a cross-sectional view of the overall configuration of the printer 1.

FIG. 3 is a diagram showing an arrangement of nozzles.

FIG. 4 is a diagram showing an example of the flow of a printing process.

FIG. 5 is a diagram showing a transport unit 20 including a transport operation control mechanism.

FIG. 6 is a flowchart of a correction-value acquiring process.

FIG. 7A is an explanatory diagram of a manner in which correction values are obtained (1 of 3).

FIG. 7B is an explanatory diagram of the manner in which correction values are obtained (2 of 3).

FIG. 7C is an explanatory diagram of the manner in which correction values are obtained (3 of 3).

FIG. 8 is a diagram showing a manner in which test pattern printing is performed.

FIG. 9 is a schematic view showing the internal configuration of a scanner 150.

FIG. 10A is a diagram showing a standard sheet SS.

FIG. 10B is a diagram showing a manner in which a test sheet TS and the standard sheet SS are set on a document-supporting glass plate 152.

FIG. 11 is a flowchart of a step of obtaining correction values.

FIG. 12A is an explanatory diagram of an image range used in pattern position calculation.

FIG. 12B is an explanatory diagram of pattern position calculation.

FIG. 13 is an explanatory diagram of calculated pattern positions.

FIG. 14 is an explanatory diagram of calculation of the absolute position of an i-th pattern in a test pattern.

FIG. 15 is an explanatory diagram of correction values obtained for respective transport operations.

FIG. 16 is an explanatory diagram of the relationship between each pattern in the test pattern and an average correction value Ct.

FIG. 17 is a diagram showing the correction values and boundary position information stored in a memory 63.

FIG. 18 is a diagram showing information about transport operations in regular printing.

FIG. 19 is a diagram showing a manner in which regular printing is performed.

FIG. 20A is an explanatory diagram of an application pattern of an average correction value Ct(i) (1 of 4).

FIG. 20B is an explanatory diagram of an application pattern of the average correction value Ct(i) (2 of 4).

FIG. 20C is an explanatory diagram of an application pattern of the average correction value Ct(i) (3 of 4).

FIG. 20D is an explanatory diagram of an application pattern of the average correction value Ct(i) (4 of 4).

FIG. 21 is an explanatory diagram of an application pattern of a correction value Ck.

FIG. 22 is a diagram showing a comparative example for explaining the effectiveness of the printer 1 of the present embodiment.

### DESCRIPTION OF EXEMPLARY EMBODIMENTS

At least the following matters will be made clear by the explanation in the present specification and the description of the accompanying drawings.

A liquid ejecting apparatus including:

an upstream-side transport roller and a downstream-side transport roller that are respectively provided on an upstream side and a downstream side in a transport direction of a medium, and that transport the medium by rotating while the medium being sandwiched therewith;

an ejecting section that ejects liquid to the medium; and

a controller

that carries out repeatedly, in an alternating manner, a transport operation of the medium by at least either one of the upstream-side transport roller and the downstream-side transport roller and an ejection operation of the liquid by the ejecting section;

that stores in advance a correction value for correcting a pre-correction target transport amount for transporting the medium, the correction value being associated with a range from a first position where the medium is located in the transport direction when the medium is sandwiched with both of the upstream-side transport roller and the downstream-side transport roller to a second position where the medium is located in the transport direction when the medium is sandwiched with only the downstream-side transport roller of both transport rollers;

that carries out the transport operation based on a post-correction target transport amount in the case where the controller carries out the transport operation in such a manner as the medium is transported from a third position upstream in the transport direction from the second position to a fourth position downstream in the transport direction from the first position and the third position, the post-correction target transport amount being obtained by correcting, using the correction value, the pre-correction target transport amount for transporting the medium from the third position to the fourth position; and

that carries out the transport operation in such a manner as the medium is transported from a position upstream in the transport direction from the first position to a position downstream in the transport direction from the second position in the case where the transport operation is carried out in such a manner as the medium is transported from the third position to the fourth position.

With such a liquid ejecting apparatus, in a transport operation to which the correction value corresponding to the transport error due to kicking-off is applied, the medium is transported so as to pass through a kicking-off occurring range (described later). Thus, this correction value properly exerts the correction effect on the transport error due to kicking-off, and consequently, the transport operation that transports the medium can be properly carried out.

Moreover, it is also possible that the liquid ejecting apparatus is a printing apparatus for printing an image on the medium; the controller stores in advance a print start position that is set in such a manner as the third position is upstream in the transport direction from the first position and the fourth position is downstream in the transport direction from the second position; and before the start of the ejection operation by the ejecting section, moves the medium to the print start position in the transport direction by making the transport rollers carry out the transport operation.

In such a case, a transport operation to which the correction value is applied is allowed to be easily set in such a manner as kicking-off occurs during the transport operation.

Moreover, it is also possible that, in carrying out the transport operation in such a manner as the medium is transported from the third position to the fourth position downstream in the transport direction from the third position, the controller carries out the transport operation in such a manner as the medium is transported from a position upstream in the transport direction from the first position to a position downstream in the transport direction from the second position and a midpoint between the third position and the fourth position coincides with a midpoint between the first position and the second position.

In such a case, it is possible to cause kicking-off to occur during a transport operation to which the correction value is applied, even when a movement range of the medium in that transport operation is displaced from the theoretical range (that is, a range from the third position to the fourth position) under the influence of, for example, disturbance.

Moreover, it is also possible that the controller stores in advance the correction value that is obtained based on formation positions of a first pattern and a second pattern on the medium, the first pattern being formed by carrying out the ejection operation when the medium is sandwiched with both transport rollers and the second pattern being formed by carrying out the ejection operation when the medium is sandwiched with only the downstream-side transport roller of both transport rollers.

In such a case, the correction value is a value that is obtained in a simple and appropriate manner.

A method for moving a medium by repeatedly carrying out a transport operation by at least either one of an upstream-side transport roller and a downstream-side transport roller, the method including:

storing a correction value for correcting a pre-correction target transport amount for transporting the medium, the correction value being associated with a range from a first position where the medium is located in a transport direction when the medium is sandwiched with both of the upstream-side transport roller and the downstream-side transport roller to a second position where the medium is located in the transport direction when the medium is sandwiched with only the downstream-side transport roller of both transport rollers; and

in the case of carrying out the transport operation in such a manner as the medium is transported from a third position upstream in the transport direction from the second position to a fourth position downstream in the transport direction from the first position and the third position,

carrying out the transport operation based on a post-correction target transport amount in such a manner as the medium is transported from a position upstream in the transport direction from the first position to a position downstream in the transport direction from the second position, the post-correction target transport amount being obtained by correcting, using the correction value, the pre-correction target transport amount for transporting the medium from the third position to the fourth position.

With such a method, the medium can be properly moved by properly carrying out the transport operation for transporting the medium.

### Configuration of Liquid Ejecting Apparatus of Present Embodiment

A liquid ejecting apparatus of the present embodiment will be described using an inkjet printer (hereinafter referred to as a printer 1) as a specific example, the inkjet printer serving as a printing apparatus that prints an image on a medium by ejecting ink, which is an example of the liquid, onto the medium.

### Basic Configuration of Printer

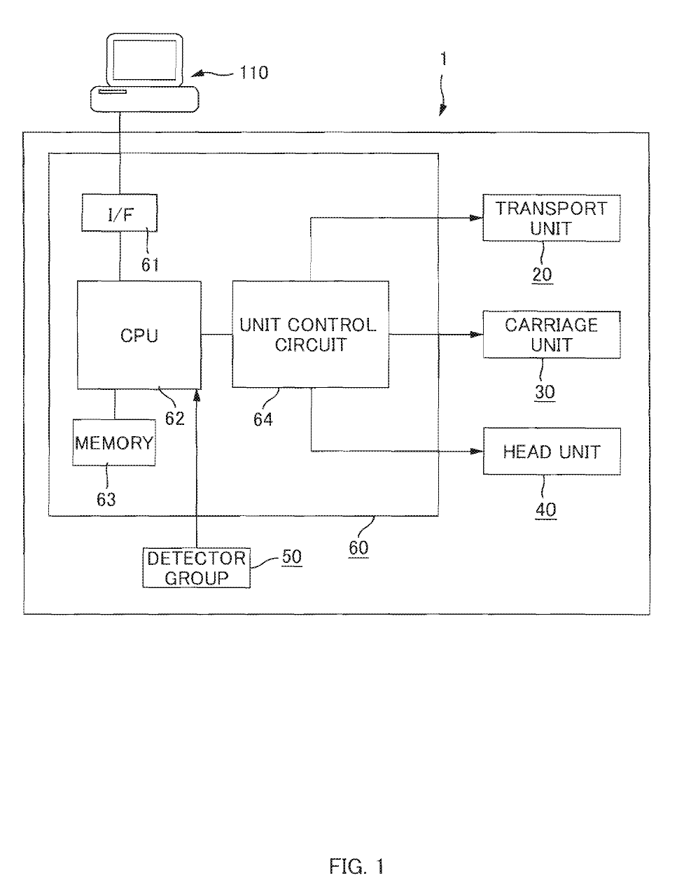

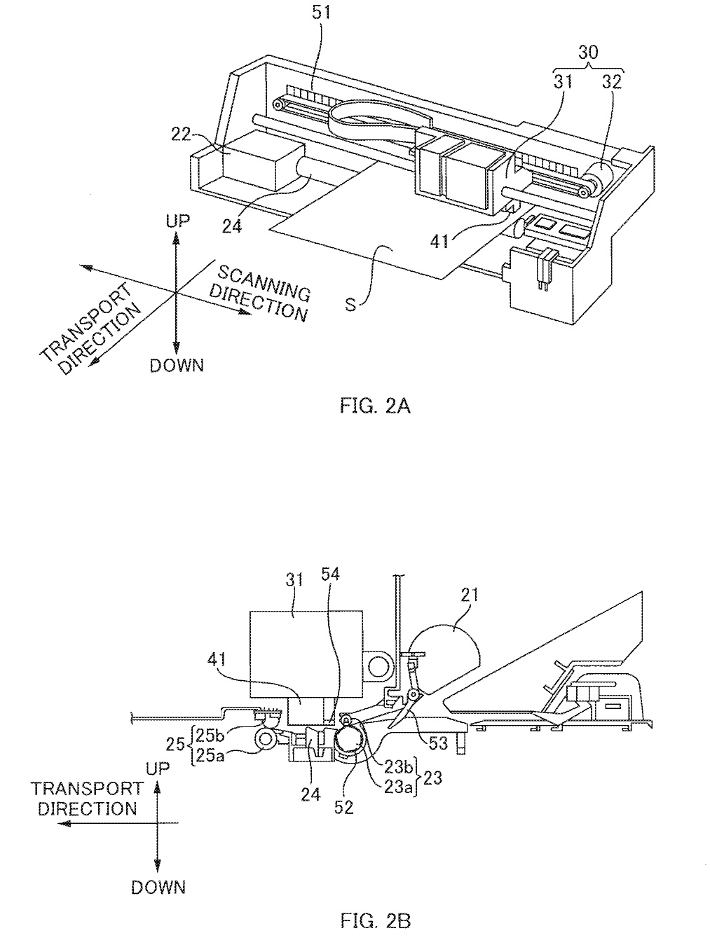

First, the basic configuration of the printer 1 will be described using FIGS. 1, 2A, and 2B. FIG. 1 is a block diagram of the overall configuration of the printer 1. FIG. 2A is a schematic view of the overall configuration of the printer 1. FIG. 2B is a cross-sectional view of the overall configuration of the printer 1. Note that a transport direction of the medium and a scanning direction of a head 41 are indicated by arrows in FIG. 2A. Moreover, the transport direction is indicated by an arrow in FIG. 2B.

As shown in FIG. 1, the printer 1 has a transport unit 20, a carriage unit 30, a head unit 40, a detector group 50, and a controller 60. Upon having received print data from a computer 110, which is an external device, the printer 1 controls various units (the transport unit 20, the carriage unit 30, and the head unit 40) using the controller 60. The controller 60 controls the units based on the print data received from the computer 110, to print an image on paper S, which is an example of the medium. The detector group 50 monitors conditions within the printer 1 and outputs detection results to the controller 60. The controller 60 performs control in accordance with the detection results output from the detector group 50.

The transport unit 20 is a unit for transporting the paper S in a predetermined direction (hereinafter referred to as the transport direction). The transport unit 20 has a paper feed roller 21, a transport motor (hereinafter referred to as a PF motor 22), a pair of upstream-side transport rollers 23, a platen 24, and a pair of downstream-side transport rollers 25 (see FIGS. 2A and 2B). The paper feed roller 21 is a roller for feeding the paper S that has been inserted into a paper insert opening into the printer. The upstream-side transport rollers 23 consists of a paper-feed roller 23a and a driven roller 23b, and are provided closer to an upstream side than the platen 24 in the transport direction of the paper S. The paper-feed roller 23a of the upstream-side transport rollers 23 is driven by the PF motor 22. The platen 24 supports the paper S that is being printed. The downstream-side transport rollers 25 consists of a paper-discharge roller 25a and a driven roller 25b, and are provided closer to a downstream side than the platen 24 in the transport direction. The paper-discharge roller 25a of the downstream-side transport rollers 25 rotates in synchronization with the paper-feed roller 23a. Note that the upstream-side transport rollers 23 and the downstream-side transport rollers 25 will be described in detail later.

As shown in FIG. 2A, the carriage unit 30 has a carriage 31 and a carriage motor 32. In order to move the head 41, which will be described later, in a predetermined direction (hereinafter referred to as the scanning direction), the carriage unit 30 moves in the scanning direction. Moreover, the carriage 31 detachably retains ink cartridges that contain ink.

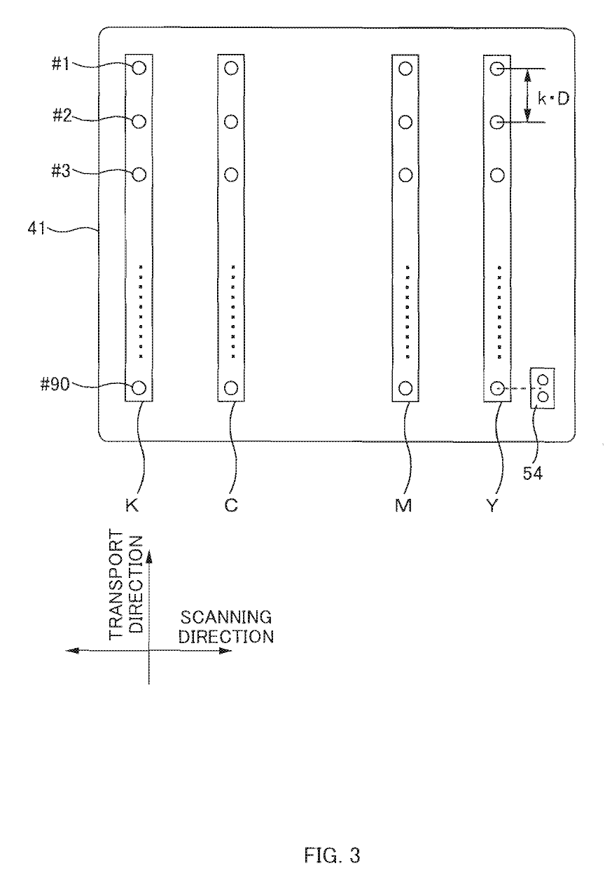

As shown in FIG. 2A, the head unit 40 includes the head 41 having a plurality of nozzles (see FIG. 3) formed in a lower surface of the head unit 40. The head 41 is an example of the ejecting section and is provided on the carriage 31. Thus, the head 41 moves in the scanning direction as the carriage 31 moves. The nozzles intermittently eject ink while the head 41 moves, and thus a dot line (raster line) is formed on the paper S along the scanning direction.

The detector group 50 includes a linear encoder 51 for detecting the position of the carriage 31 in the scanning direction, a rotary encoder 52 for detecting the rotation amount of the paper-feed roller 23a, a paper detection sensor 53 for detecting the position of a front end of the paper S that is being fed, an optical sensor 54 for detecting whether or not the paper S is present, and so on. Note that the optical sensor 54 can also detect front and rear ends of the paper S as the situation demands.

The controller 60 is for controlling the printer 1. The controller 60 includes an interface 61, a CPU 62, a memory 63, and a unit control circuit 64. The interface 61 exchanges data between the computer 110 and the printer 1. The CPU 62 is a processing unit for carrying out overall control of the printer. The memory 63 has storage devices such as a RAM or an EEPROM. The CPU 62 controls the units via the unit control circuit 64 according to programs stored in the memory 63.

### Regarding Transport Rollers

Both of the upstream-side transport rollers 23 and the downstream-side transport rollers 25 are rollers for transporting the paper S in the transport direction by rotating while the paper S being sandwiched therebetween. The manner in which the upstream-side transport rollers 23 and the downstream-side transport rollers 25 move the paper S within the printer 1 in the transport direction will be described below.

The paper S that has been fed into the printer by the paper feed roller 21 is initially sandwiched between the paper-feed roller 23a and the driven roller 23b and transported in the transport direction by only the upstream-side transport rollers 23. When the paper S continues being transported in the transport direction while remaining sandwiched between the upstream-side transport rollers 23, an end (front end) of the paper S on the downstream side in the transport direction is soon sandwiched between the paper-discharge roller 25a and the driven roller 25b. In other words, the paper S is sandwiched between both of the upstream-side transport rollers 23 and the downstream-side transport rollers 25, and the paper S is transported further downstream in cooperation with those transport rollers. When the paper S continues being transported with being sandwiched between both of those transport rollers, an end (rear end) of the paper S on the upstream side in the transport direction soon comes off the upstream-side transport rollers 23. In other words, the paper S is now sandwiched between only the downstream-side transport rollers 25 of those transport rollers, and thereafter the paper S continues being transported in the transport direction by only the downstream-side transport rollers 25 and is finally discharged to the outside of the printer.

### Regarding Nozzles

Next, with reference to FIG. 3, an arrangement of the nozzles in the lower surface of the head 41 will be described. FIG. 3 is a diagram showing the arrangement of the nozzles, and the transport direction and the scanning direction are indicated by arrows in FIG. 3.

As shown in FIG. 3, a black ink nozzle group K, a cyan ink nozzle group C, a magenta ink nozzle group M, and a yellow ink nozzle group Y are formed in the lower surface of the head 41. Each nozzle group has 90 nozzles for ejecting ink of a color corresponding to the nozzle group.

The plurality of nozzles in each nozzle group are arranged in a row at a constant spacing (nozzle pitch: k-D) along the transport direction and form a nozzle row. Note that in FIG. 3, the nozzles constituting each nozzle row are assigned a number (#1 to #90) that become smaller toward the downstream side. Here, D is the minimum dot pitch (spacing of dots formed on the paper S at the highest resolution) in the transport direction. Moreover, k is an integer of 1 or more, and k=8 in the present embodiment because the nozzle pitch is 90 dpi ( 1/90 inch) and the dot pitch in the transport direction is 720 dpi ( 1/720 inch). Note that the position of the above-described optical sensor 54 in a direction parallel to the transport direction is substantially the same as the position of the furthest upstream nozzle #90.

An ink chamber and a piezo element (both of the ink chamber and the piezo element are not shown) are provided for each nozzle. When the piezo element is driven, the ink chamber shrinks and expands accordingly, and thus the nozzle ejects ink in the form of a droplet.

### Regarding Printing Process

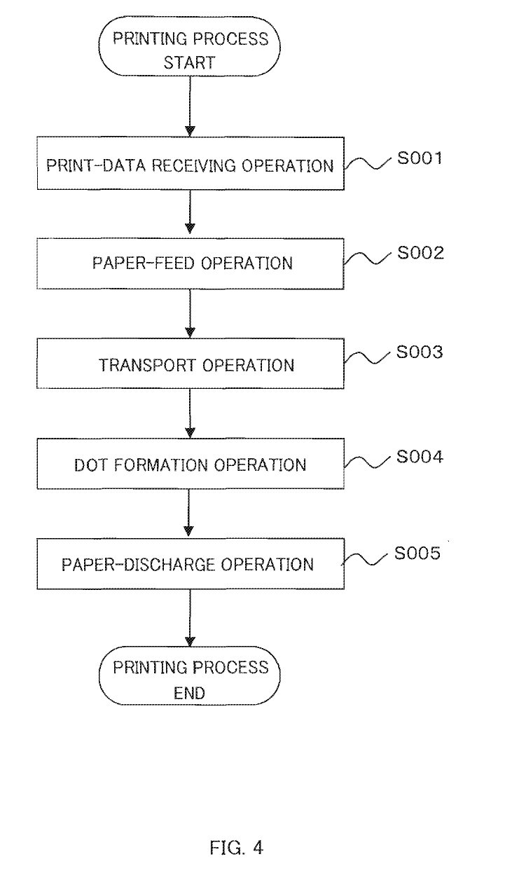

Next, a printing process for printing an image on the paper S will be described using FIG. 4. FIG. 4 is a flowchart of the printing process.

As shown in FIG. 4, the printing process consists of a print-data receiving operation (S001), a paper-feed operation (S002), a transport operation (S003), a dot formation operation (S004), and a paper-discharge operation (S005). The controller 60 carries out each operation by controlling the units.

The print-data receiving operation is an operation in which the controller 60 receives print data from the computer 110 via the interface 61. The controller 60 analyzes various commands contained in the print data and performs the following operations by controlling the units.

The paper-feed operation is an operation in which the paper S is fed into the printer by the paper feed roller 21. The transport operation is an operation in which the paper S is transported in the transport direction by at least either set of rollers among the upstream-side transport rollers 23 and the downstream-side transport rollers 25. The controller 60 moves the paper S relative to the head 41 in the transport direction by making the transport rollers carry out the transport operation.

The dot formation operation is an ink ejection operation, and is an operation that forms a raster line constituted by a plurality of dots on the paper S by intermittently ejecting ink from the nozzles of the head 41 that is moving in the scanning direction. The dot formation operation and the transport operation are carried out repeatedly in an alternating manner. Thus, when the transport operation is carried out after a dot formation operation that forms a raster line at a certain position on the paper S, the subsequent dot formation operation can form a raster line at a different position (different position in the transport direction) on the paper S from the above-described certain position.

More specifically, in the printing process in which a single piece of paper S is printed, a transport operation (hereinafter also referred to as an initial transport operation) for positioning the paper S that has been fed into the printer at a print start position (also referred to as the indexing position) is carried out after the end of the paper-feed operation and before the start of the dot formation operation. Then, based on the print data that has been received by the print-data receiving operation, the dot formation operation and the transport operation are carried out repeatedly and alternately. As a result, a plurality of raster lines are lined up in the transport direction on the paper S, and an image is printed on the paper S. Then, at the time when printing of the image is completed, the controller 60 makes the downstream-side transport rollers 25 carry out the paper-discharge operation (S005) for discharging the paper S to the outside of the printer.

Thereafter, the controller 60 causes the units to carry out the above-described operations, and then determines whether or not to continue printing. In the case where printing on the next piece of paper S is performed, the controller 60 returns the printing process to the paper-feed operation and continues the printing process. On the other hand, in the case where printing on the next piece of paper S is not performed, the printing process is ended.

### Regarding Formation of Raster Lines

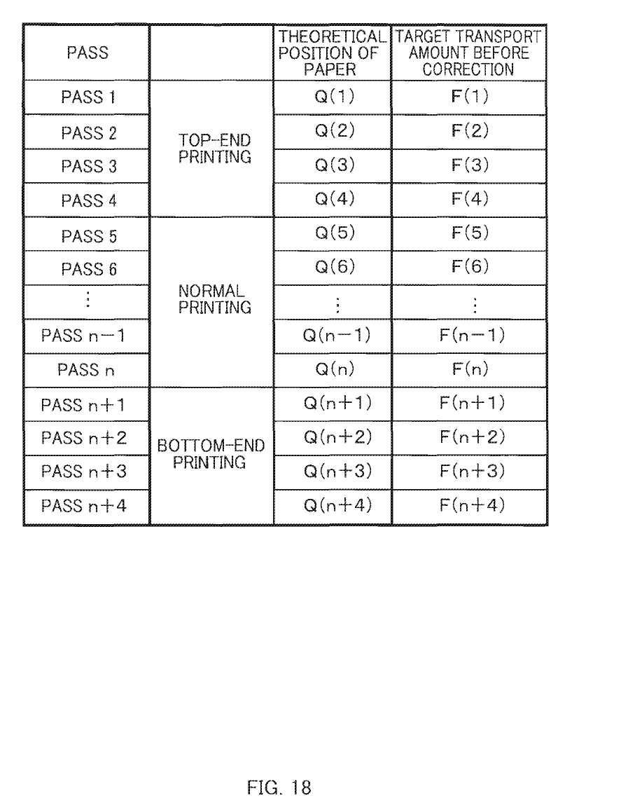

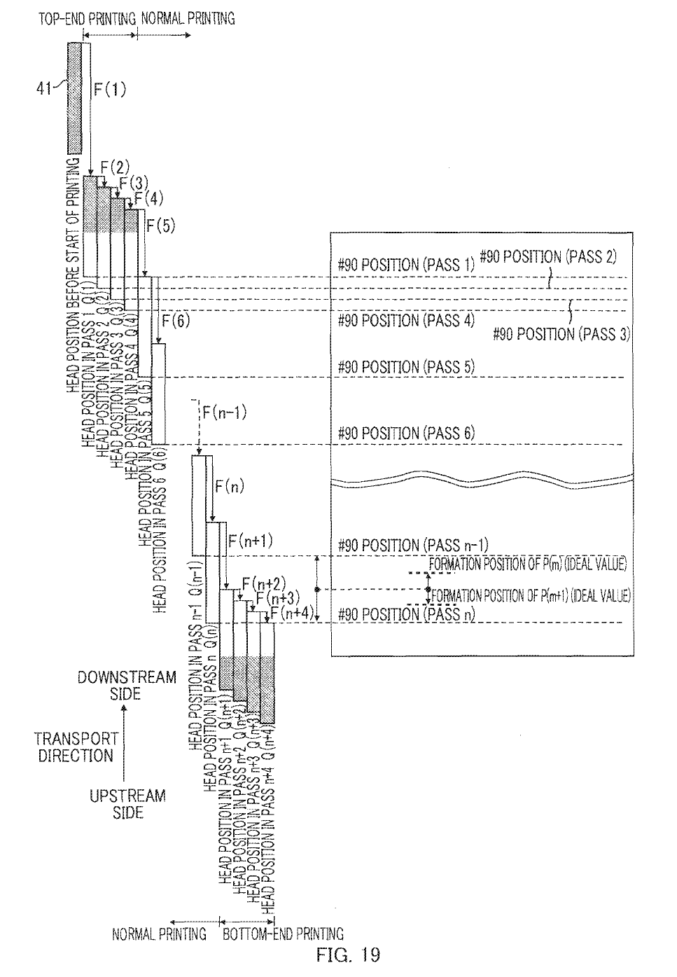

The printing process of the present embodiment is divided into three steps, namely, top-end printing, normal printing, and bottom-end printing in accordance with the formation position of the raster lines (see FIG. 18 or 19, for example).

The normal printing is performed in a printing method (interlaced printing) in which a raster line that is not recorded is sandwiched between raster lines that are recorded in a single pass. Note that a “pass” refers to a dot formation operation, and “pass x” means an x-th dot formation operation. In the interlaced printing of the present embodiment, when a pass in which a certain raster line is formed is given as pass x, a raster line is formed in pass x+1 at a position that is immediately above the certain raster line (position closer to the front end than the certain raster line by an amount D).

Top-end printing and bottom-end printing are performed in order to form a raster line in an area where raster lines cannot be formed continuously in the transport direction by simply performing normal printing. Top-end printing is performed before normal printing in order to form a raster line near the front end of the paper S. Bottom-end printing is performed after normal printing in order to form a raster line near the rear end of the paper S. Note that the transport amount in a transport operation that is carried out during top-end printing or bottom-end printing is small compared to the transport amount during normal printing.

### Regarding Transport Operation Control Mechanism

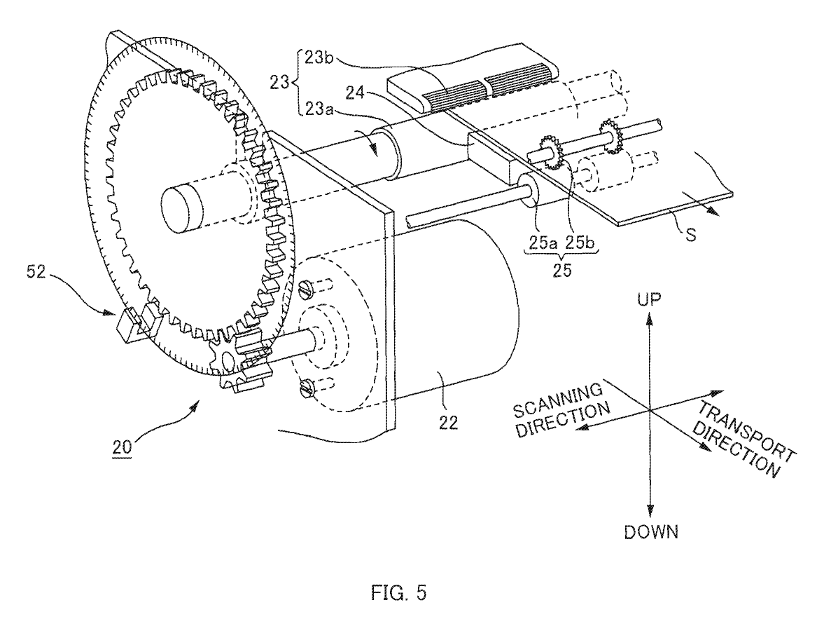

Next, a control mechanism for transport operation will be described using FIG. 5. FIG. 5 is a perspective view showing the transport unit 20 including the control mechanism.

Of the upstream-side transport rollers 23 and the downstream-side transport rollers 25, in order to make at least the upstream-side transport rollers 23 carry out the transport operation, the controller 60 drives the PF motor 22 by a predetermined drive amount. When the PF motor 22 is driven by the predetermined drive amount, the paper-feed roller 23a rotates by a predetermined rotation amount. Accordingly, the upstream-side transport rollers 23 transport the paper S by a predetermined transport amount. Here, the transport amount of the paper S is determined depending on the rotation amount of the paper-feed roller 23a. In the present embodiment, when the paper-feed roller 23a performs a full rotation, the paper is transported by one inch (that is, the circumference of the paper-feed roller 23a is one inch). Therefore, if the rotation amount of the paper-feed roller 23a can be detected, the transport amount of the paper can also be detected. For this reason, the above-described rotary encoder 52 is provided in the present embodiment.

Then, for example, in the case where the paper S is transported by a targeted transport amount (target transport amount) of one inch, the controller 60 drives the PF motor 22 until the rotary encoder 52 detects that the paper-feed roller 23a completes a full rotation. In this manner, the controller 60 drives the PF motor 22 until the rotary encoder 52 detects a rotation amount corresponding to the target transport amount.

On the other hand, in the case where only the downstream-side transport rollers 25, of the upstream-side transport rollers 23 and the downstream-side transport rollers 25, carry out the transport operation, the rotation amount of the paper-discharge roller 25a is detected. The controller 60 rotates the paper-discharge roller 25a until the rotation amount reaches a rotation amount corresponding to the target transport amount.

### Regarding Transport Errors

Note that the rotary encoder 52 detects the rotation amount of the paper-feed roller 23a, and strictly speaking does not detect the transport amount of the paper S. For this reason, in the case where the rotation amount of the paper-feed roller 23a does not agree with the transport amount of the paper S, the rotary encoder 52 cannot precisely detect the transport amount of the paper S, so that this detection error causes a transport error. There are two types of transport errors due to the detection error: a DC component transport error and an AC component transport error.

The DC component transport error refers to a predetermined amount of transport error that occurs when the paper-feed roller 23a completes a full rotation. It can be considered that the DC component transport error is caused by the circumference of the paper-feed roller 23a varying from one printer to another because of a manufacturing error and the like. That is to say, the DC component transport error is a transport error that is caused by the difference between the design circumference of the paper-feed roller 23a and the actual circumference of the paper-feed roller 23a. The DC component transport error is constant irrespective of the position of the paper-feed roller 23a when the paper-feed roller 23a starts to perform a full rotation. However, the DC component transport error actually varies depending on the total transport amount of the paper S due to the influence of friction of the paper S or the like. In other words, the actual DC component transport error is a value that varies depending on the relative positional relationship between the paper S and the paper-feed roller 23a (or between the paper S and the head 41).

The AC component transport error refers to a transport error corresponding to a location that is on a circumferential surface of the paper-feed roller 23a and that is used during transport. The AC component transport error varies in amount depending on the location that is on the circumferential surface of the paper-feed roller 23a and that is used during transport. That is to say, the AC component transport error varies in amount depending on the rotation position of the paper-feed roller 23a when transport commences and the transport amount. It can be considered that the AC component transport error is caused by the influence of the shape of the paper-feed roller 23a (e.g., in the cases where the paper-feed roller 23a has an elliptical shape or an oval shape), the eccentricity of the rotation axis of the paper-feed roller 23a, the misalignment between the rotation axis of the paper-feed roller 23a and the center of the scale of the rotary encoder 52, and so on.

Furthermore, when the paper S sandwiched between the upstream-side transport rollers 23 and between the downstream-side transport rollers 25 continues being transported, the above-described kicking-off occurs at the moment when the rear end of the paper S comes off the upstream-side transport rollers 23, and this kicking-off causes a transport error.

More specifically, immediately before the rear end comes off the upstream-side transport rollers 23, the area of the paper S that is sandwiched between the upstream-side transport rollers 23 decreases. On the other hand, the force applied to the paper S by the upstream-side transport rollers 23 for the purpose of keeping the paper S sandwiched is substantially constant. Thus, at the moment when the rear end comes off the upstream-side transport rollers 23, the sandwiching pressure by the upstream-side transport rollers 23 excessively acts on the paper S. As a result, when kicking-off occurs during a certain transport operation, the paper S is transported by a smaller transport amount than the original target transport amount of the certain transport operation.

In order to give consideration to transport errors as described above, in the present embodiment, a process (hereinafter referred to as the correction-value acquiring process) of obtaining correction values for correcting the target transport amount in individual transport operations is performed before shipment of the printer 1. The correction values obtained by this correction-value acquiring process reflect the properties of the fully assembled printer 1 to transport the paper S, and are stored in the memory 63 of the computer 60.

After the completion of the correction-value acquiring process, the printer 1 is shipped to a user. Under the user who purchased the printer 1, the controller 60 performs an image printing process (hereinafter also referred to as regular printing) based on print data sent from the computer 110 owned by the user. During regular printing, the controller 60 reads the correction values from the memory 63, corrects the original target transport amount using the correction values, and carries out the transport operation based on the corrected target transport amount.

Note that in the following description, the original target transport amount before being corrected using the correction values is also called a pre-correction target transport amount, and the corrected target transport amount is also called a post-correction target transport amount.

### Regarding Correction-Value Acquiring Process

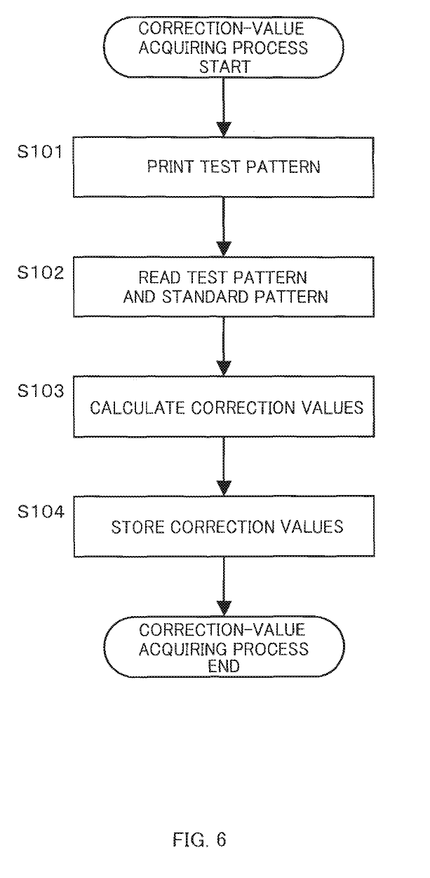

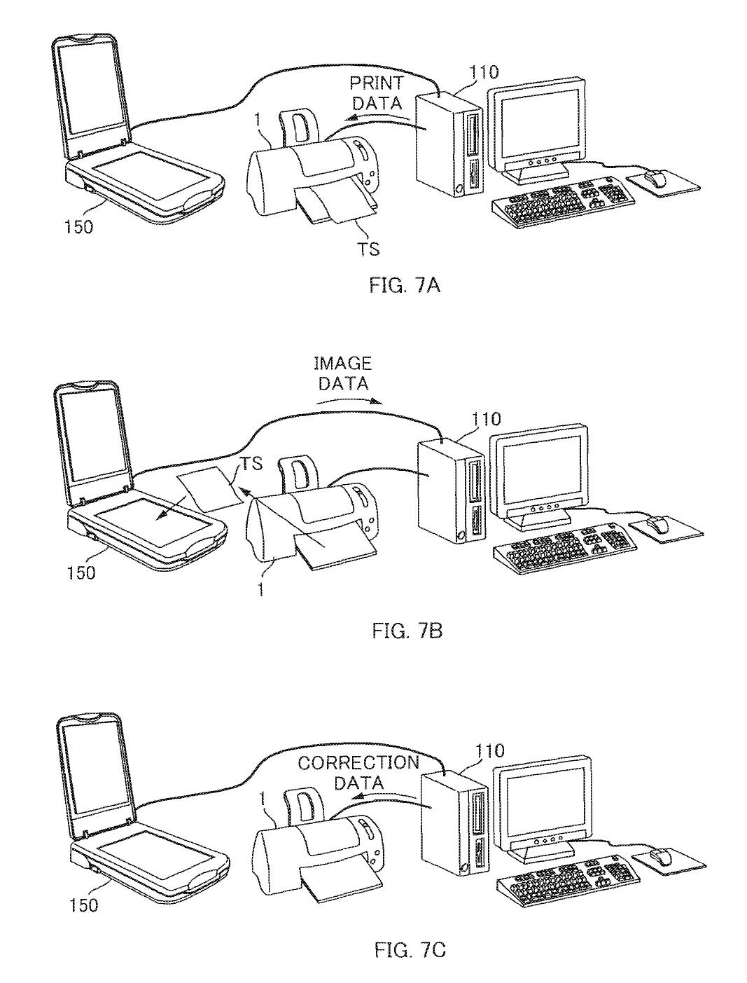

The above-described correction-value acquiring process will be described using FIGS. 6 and 7A to 7C. FIG. 6 is a flowchart of the correction-value acquiring process. FIGS. 7A to 7C are diagrams showing how correction values are obtained.

As shown in FIG. 6, the correction-value acquiring process includes a step (S101) of printing a test pattern, a step (S102) of reading the test pattern and a standard pattern, a step (S103) of calculating correction values, and a step (S104) of storing the correction values. These steps are each performed before shipment of the printer 1, for example, in an inspection process at a printer factory. Prior to this process, an inspector connects the printer 1 that is fully assembled to the computer 110 at the factory. The computer 110 at the factory is also connected to a scanner 150 and is preinstalled with a printer driver, a scanner driver, and a correction-value acquiring program. The steps in the correction-value acquiring process will be described below.

First, as shown in FIG. 7A, the printer driver sends print data for printing of a test pattern to the printer 1, and the printer 1 prints the test pattern on a test sheet TS based on the print data. That is to say, the controller 60 of the printer 1 performs a mode (hereinafter referred to as test pattern printing) of forming the test pattern on the test sheet TS by repeatedly carrying out the transport operation and the dot formation operation in an alternating manner based on the print data received from the printer driver. Note that the test sheet TS that is used in test pattern printing is of the same type (size and material) as the paper S that is used in regular printing.

Next, as shown in FIG. 7B, the inspector sets the test sheet TS in the scanner 150, and the scanner driver makes the scanner 150 read the test pattern and acquires image data of the test pattern. At this time, a standard sheet SS is set in the scanner 150 along with the test sheet TS, and the standard pattern drawn on the standard sheet SS is also read together.

Subsequently, the correction-value acquiring program analyzes the image data and obtains correction values based on the analysis results. As shown in FIG. 7C, after obtaining the correction values, the correction-value acquiring program sends data of the correction values to the printer 1. Then, the correction values are stored in the memory 63 of the controller 60.

### Test Pattern Printing

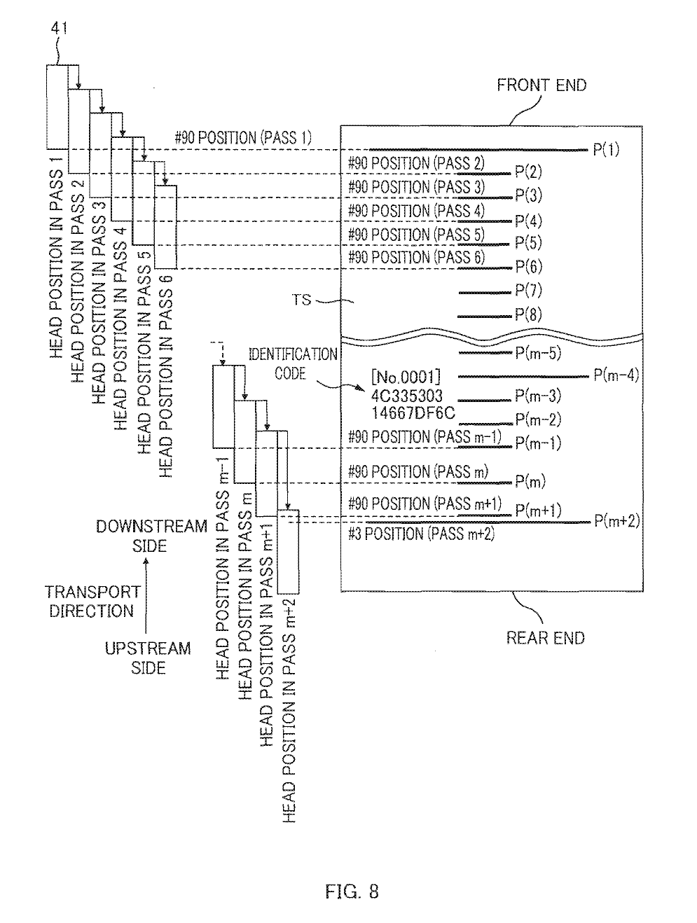

The step of printing the test pattern will be described using FIG. 8. FIG. 8 is a diagram showing a manner in which test pattern printing is performed. The test pattern printed on the test sheet TS is shown on the right side of FIG. 8. Rectangles shown on the left side of FIG. 8 indicate the position of the head 41 in each pass. For convenience of illustration, the head 41 is illustrated as if moving with respect to the test sheet TS. However, FIG. 8 shows the relative position of the test sheet TS with respect to the head 41, and in fact the test sheet TS is intermittently transported in the transport direction.

As shown in FIG. 8, the test pattern is constituted by an identification code and a plurality of patterns in the form of ruled lines (hereinafter simply referred to as the patterns).

The identification code is a symbol for individual identification for identifying each of the individual printers 1. By reading the identification code during reading of the test pattern, the computer 110 identifies the printer that will be subject to the correction-value acquiring process.

Each of the plurality of patterns is a ruled line that is formed along a paper width direction of the test sheet TS, that is, the scanning direction of the head 41. During test pattern printing, every time the transport operation is carried out (in other words, in every pass), a pattern is formed sequentially from the front end side of the test sheet TS. Thus, the plurality of patterns are lined up along the transport direction on the test sheet TS.

Among the plurality of patterns, patterns P(1) to P(m) that are formed in pass 1 to pass m are formed while the test sheet TS is sandwiched between at least the upstream-side transport rollers 23, of the upstream-side transport rollers 23 and the downstream-side transport rollers 25. Moreover, the pattern P(m) is positioned closest to the rear end among patterns that are formed while the test sheet TS is sandwiched between the upstream-side transport rollers 23 and between the downstream-side transport rollers 25. On the other hand, patterns P(m+1) and P(m+2) that are formed in pass m+1 and pass m+2 are formed while the test sheet TS is sandwiched between only the downstream-side transport rollers 25. The test pattern as described above is formed in the following manner.

First, when the test sheet TS is in a print start position for test pattern printing, the pattern P(1) is formed by ink ejected from only the nozzle #90 in pass 1. After the formation of the pattern P(1), the controller 60 carries out a transport operation that transports the test sheet TS by ⅛ inch by making the paper-feed roller 23a perform a ⅛ rotation. When this transport operation is completed, a pattern P(2) is formed by ink ejected from only the nozzle #90 in pass 2. Thereafter, the similar operation is repeated, and thus patterns P(3) to P(m−1) are formed at intervals of ⅛ inch. After the formation of the pattern P(m−1), the controller 60 carries out a transport operation that transports the test sheet TS by a predetermined amount in the transport direction, and moves the test sheet TS further downstream. When this transport operation is completed, the pattern P(m) is formed by ink ejected from only the nozzle #90 in pass m.

After the formation of the pattern P(m), the controller 60 carries out a transport operation that transports the test sheet TS further downstream by ⅙ inch. When this transport operation is completed, the pattern P(m+1) is formed by ink ejected only from the nozzle #90 in pass m+1.

Incidentally, as described above, the pattern P(m) is closest to the rear end among the patterns that are formed while the test sheet TS is sandwiched between the upstream-side transport rollers 23 and between the downstream-side transport rollers 25. On the other hand, the pattern P(m+1) is closest to the front end among the patterns that are formed while the test sheet TS is sandwiched between only the downstream-side transport rollers 25. Therefore, two patterns that are adjacent to each other in the test pattern and that are formed before and after the occurrence of the above-described kicking-off are the pattern P(m) and the pattern P(m+1).

Here, of the two adjacent patterns that are formed immediately before and after the occurrence of kicking-off, the pattern that is closer to the front end is referred to as a first pattern, and the pattern that is closer to the rear end is referred to as a second pattern. That is to say, the pattern P(m) corresponds to the first pattern and the pattern (m+1) corresponds to the second pattern, and kicking-off occurs during the transport operation between pass m and pass m+1. In the present embodiment, the theoretical position of the test sheet TS in pass m and the theoretical position of the test sheet TS in pass m+1 are set in advance with consideration given to the kicking-off occurring position.

More specifically, the kicking-off occurring position is theoretically estimated with consideration given to the mechanical properties of the printer 1 and the type of the test sheet TS. With respect to the estimated kicking-off occurring position, variations are also taken into consideration. Then, a range (hereinafter referred to as the kicking-off occurring range) in which the kicking-off occurring position is highly likely to be present is determined. The respective theoretical positions in pass m and pass m+1 are set in such a manner as the theoretical positions are each located at boundary positions in the transport direction on both sides of the kicking-off occurring range that has been determined in this manner. Thus, the kicking-off occurring position is reliably present in between the theoretical position in pass m and the theoretical position in pass m+1 (that is, the kicking-off occurring range).

After the formation of P(m+1), the controller 60 carries out a transport operation that transports the test sheet TS further downstream by about one inch by rotating the paper-discharge roller 25a. When this transport operation is completed, the pattern P(m+2) is formed by ink ejected from only the nozzle #3 in pass m+2.

As described above, all of the patterns excluding the pattern P(m+2) are formed by ejecting ink from only a predetermined nozzle (the furthest upstream nozzle #90) of the nozzles #1 to #90. Here, the interval (pattern interval) between two adjacent patterns of the patterns that are formed by ejecting ink from the nozzle #90 is theoretically equal to the interval (theoretical position interval) between the theoretical positions at the time when each of those two patterns is formed. For example, the interval between two adjacent patterns of the patterns P(1) to P(m−1) is exactly ⅛ inch. Moreover, the interval between the pattern P(m) and the pattern P(m+1) (the interval between the first pattern and the second pattern) is exactly ⅙ inch.

Actually, however, a transport error occurs during the transport operation, resulting in a difference between the pattern interval and the theoretical position interval. Suppose that the test sheet TS is transported more than an ideal transport amount, then the pattern interval is wider than the theoretical position interval. Conversely, suppose that the test sheet TS is transported less than an ideal transport amount, then the pattern interval narrows. That is to say, each pattern interval reflects the transport error that occurs during each transport operation. Therefore, by measuring the pattern interval, it is possible to measure the transport error and to obtain a correction value for correcting the transport error.

Similarly, the interval between the pattern P(m+1) and the pattern P(m+2) should be exactly 3/90 inches in the case where transport of the test sheet TS is carried out ideally (more precisely, in addition thereto, the nozzle #90 and the nozzle #3 are same in ejection of ink). However, due to the transport error, the line interval is not 3/90 inches. Therefore, by measuring the interval between the pattern P(m+1) and the pattern P(m+2), the transport error can be measured and a correction value can thus be obtained as described above.

### Reading of Test Pattern

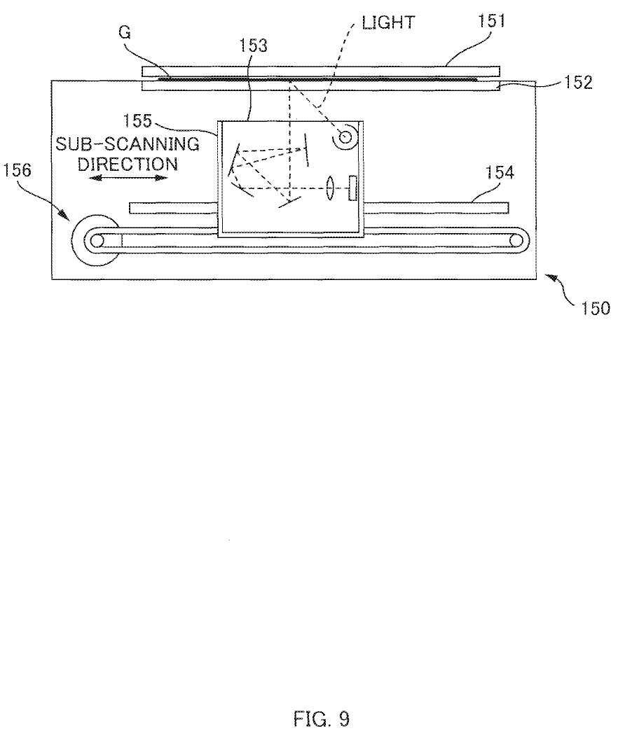

Next, the step of reading the test pattern will be described. At the beginning of the description of this step, the scanner 150 that is used to read the test pattern will be described using FIG. 9. FIG. 9 is a schematic view showing the internal configuration of the scanner 150. A moving direction (sub-scanning direction) of an image reading sensor 153 is indicated by an arrow in the figure. Note that in the following description, a direction in which a plurality of light-receiving elements (not shown) provided on the image reading sensor 153 are lined up and that is substantially perpendicular to the sub-scanning direction is referred to as a main scanning direction.

The scanner 150, with a lid 151 closed, irradiates an document G placed on the document-supporting glass plate 152 with light and reads an image on the document G by detecting the light reflected from the document G. As shown in FIG. 9, the scanner 150 is provided inside with the image reading sensor 153 that moves in the sub-scanning direction while facing the document G via the document-supporting glass plate 152, a carriage 155 that moves in the sub-scanning direction along a guide bar 154 in order to move the image reading sensor 153, a moving mechanism 156 for moving the carriage 155, and a scanner controller (not shown) that controls each section of the scanner. While moving in the sub-scanning direction, the image reading sensor 153 detects light that is radiated on and reflected from the document G. In this manner, the image on the document G set on the document-supporting glass plate 152 is read. The scanner controller sends to the computer 110 data (image data) of the image that has been read.

The test pattern on the test sheet TS is read by the scanner 150 such as that described above. Moreover, in the present embodiment, the scanner 150 has a reading resolution of 720 dpi (main scanning direction)×720 dpi (sub-scanning direction).

Incidentally, concerning the reading position of the scanner 150 when the scanner 150 reads the test pattern, an error occurs between the theoretical value of the reading position and the actual reading position. Then, the position of each pattern in the test pattern cannot be accurately measured by simply reading the test pattern in the state where there is an error in the reading position. In the present embodiment, when the scanner 150 reads the test pattern, the standard sheet SS is set so that the scanner 150 also reads the standard pattern.

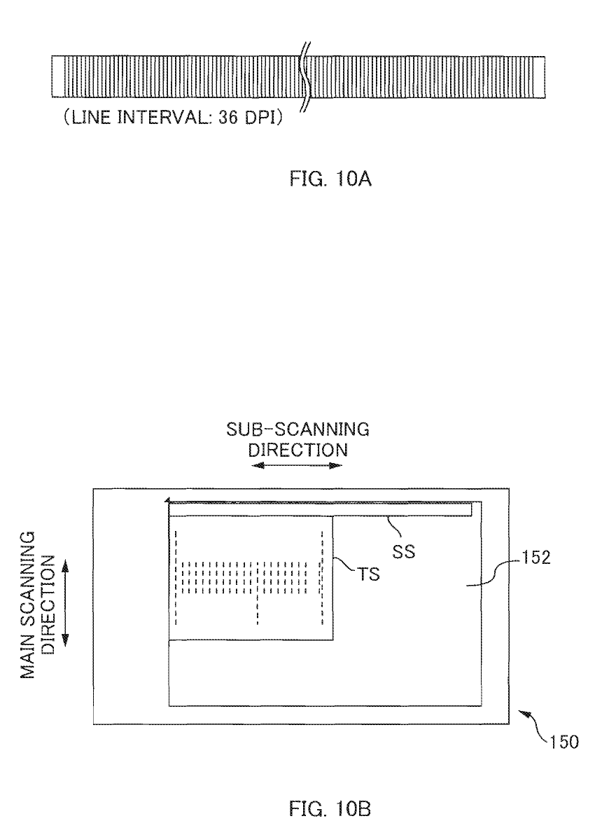

In the following, reading of the test pattern and the standard pattern will be described using FIGS. 10A and 10B. FIG. 10A is a diagram showing the standard sheet SS. FIG. 10B is a diagram showing a manner in which the test sheet TS and the standard sheet SS are set on the document-supporting glass plate 152.

The standard pattern is formed on the standard sheet SS, and as shown in FIG. 10A, the standard pattern is constituted by a plurality of lines that are lined up at intervals of 36 dpi with a high degree of precision. As shown in FIG. 10B, the test sheet TS and the standard sheet SS are set at predetermined positions on the document-supporting glass plate 152. The standard sheet SS is set in such a manner as each of the plurality of lines is parallel to the main scanning direction of the scanner 150. On the other hand, the test sheet TS is placed next to the standard sheet SS and is set in such a manner as each of the patterns is parallel to the main scanning direction.

With the test sheet TS and the standard sheet SS set in this state, the scanner 150 reads the test pattern and the standard pattern. In this manner, image data on each of the test pattern and the standard pattern is acquired. However, under the influence of the error in the reading position, the actual image data is distorted compared to the image data in the case where reading is performed ideally. Therefore, when analyzing the image data, the correction-value acquiring program cancels the influence of the error in the reading position exerted on the image data of the test pattern, based on the image data of the standard pattern.

### Calculation of Correction Values

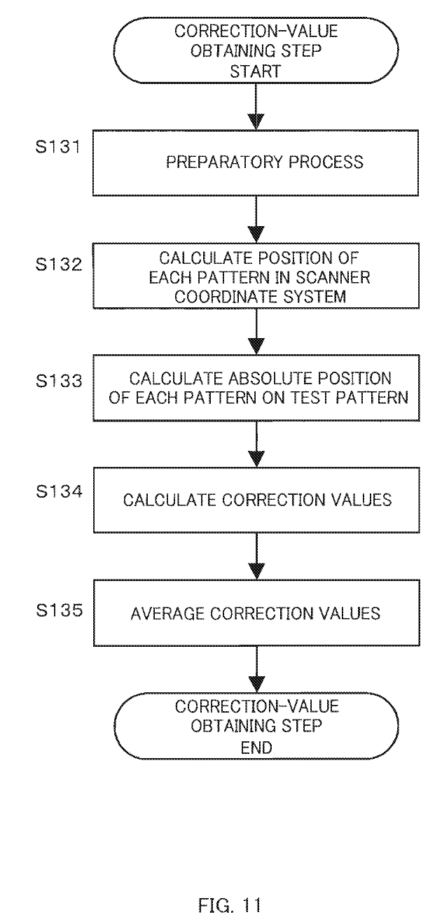

Next, the step of obtaining correction values by analyzing the image data of the test pattern will be described with reference to FIG. 11. FIG. 11 is a flowchart of the step of obtaining correction values.

### Preparatory Processes

Before obtaining the correction values, preparatory processes for analyzing the image data of the test pattern and the standard pattern acquired from the scanner 150 are performed (S131). The preparatory processes are carried out by the correction-value acquiring program. As a specific preparatory process, the image data of each of the test sheet TS and the standard sheet SS undergoes a process of correcting a tilt that occurs because each of the test sheet TS and the standard sheet SS is set in the scanner 150 with tilting. In correction of the tilt, the tilt angle of the images of each of the test pattern and the standard pattern is detected by a known detection method. Then, based on the detected tilt angle, each image is rotated to correct the tilt of the image. Note that the test pattern and the standard pattern are rotated separately. Thus, the position of the test pattern relative to the standard pattern may be displaced. In consideration of such a case, the displacement that is caused by separately rotating the patterns is evaluated in advance; and when the position of each pattern is calculated in a step (S132) of calculating the position of each pattern, the displacement is subtracted from the calculated position.

Moreover, as a subsequent preparatory process, distortion of the test pattern itself is detected. The distortion of the test pattern refers to distortion caused by the test sheet TS tilting during test pattern printing. For example, when the paper width direction of the test sheet TS starts tilting with respect to the scanning direction of the head 41 during test pattern printing, the test pattern is printed in a distorted state with respect to the test sheet TS. When the distortion of the test pattern itself becomes conspicuous, correction values that are obtained based on this test pattern are inappropriate. To avoid such a situation, the distortion of the test pattern itself is evaluated, and in the case where the distortion exceeds a specified level, this is taken as an error.

### Pattern Position Calculation

After the foregoing preparatory processes, the correction-value acquiring program calculates the position of each line of the standard pattern and the position of each pattern of the test pattern in a scanner coordinate system (S132). In the scanner coordinate system, an image that is read by the scanner 150 and thus acquired is assumed to be constituted by pixels of 1/720× 1/720 inches. Moreover, the position of a pixel at the top-left of each image is used as the origin of the scanner coordinate system.

Subsequently, the correction-value acquiring program calculates the formation position of each pattern on the test sheet TS, that is, the absolute position of each pattern based on the position of each line and the position of each pattern in the scanner coordinate system (S133).

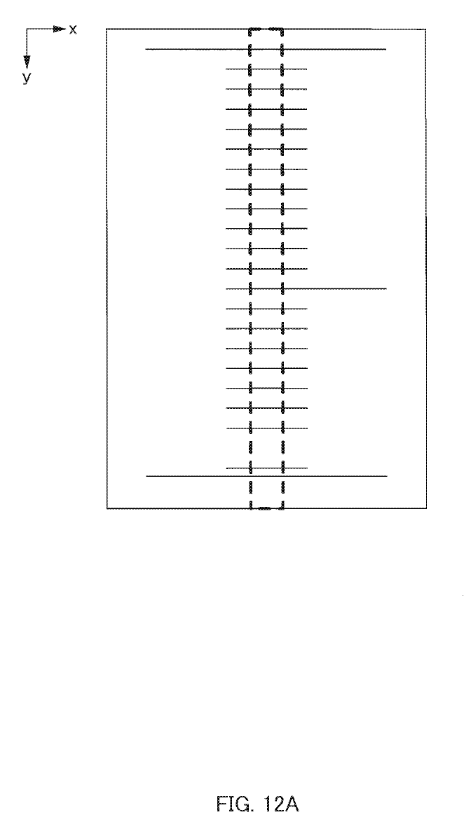

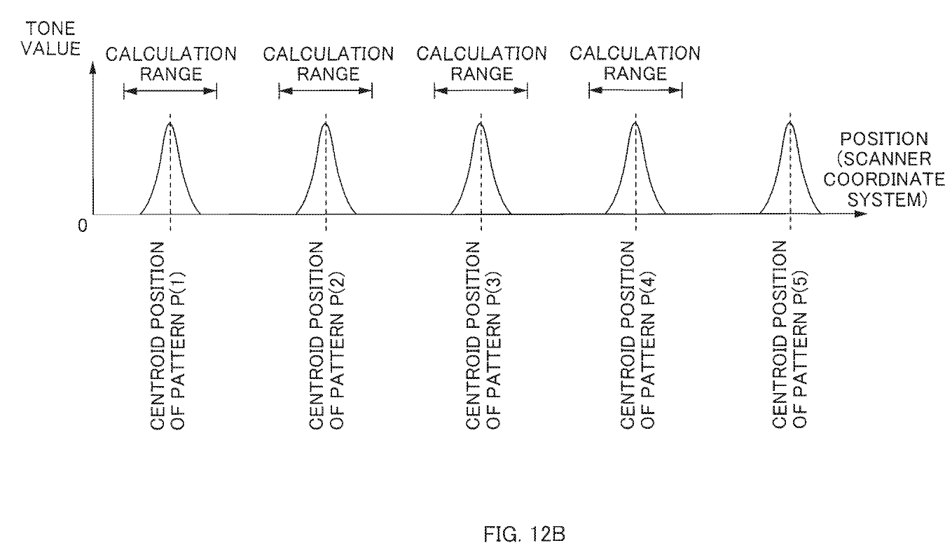

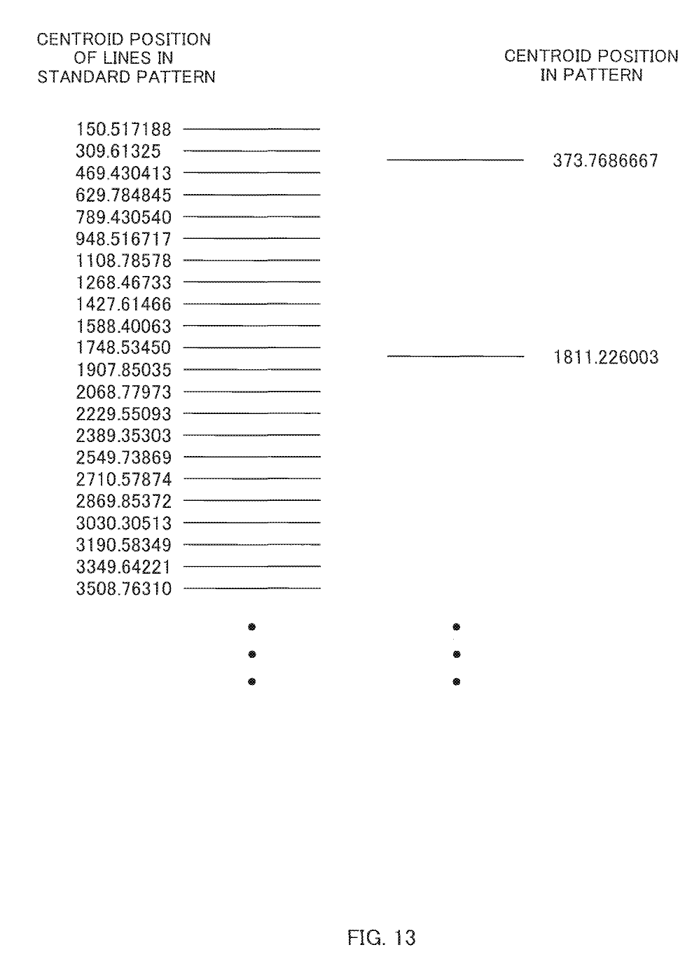

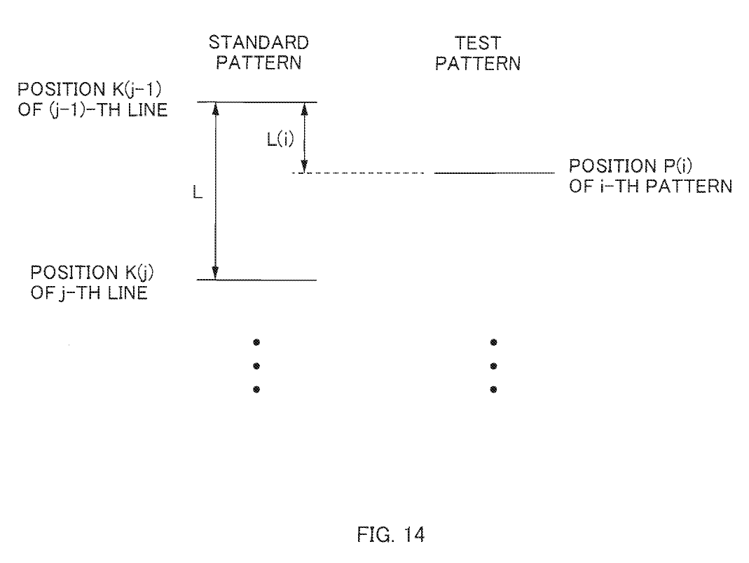

The description will be given below with reference to FIGS. 12A, 12B, 13, and 14. FIG. 12A is an explanatory diagram of an image range that is used in pattern position calculation. FIG. 12B is an explanatory diagram of pattern position calculation. The horizontal axis indicates the positions of pixels in the y direction (in the scanner coordinate system). The vertical axis indicates tone values of the pixels (average values of tone values of the pixels lined up in the x direction). FIG. 13 is an explanatory diagram of calculated pattern positions, and the positions shown in the figure have undergone a predetermined calculation to be made dimensionless. FIG. 14 is an explanatory diagram of calculation of the absolute position of an i-th pattern of the test pattern. Here, the i-th pattern of the test pattern is a pattern that is positioned between a (j−1)-th line of the standard pattern and a j-th line of the standard pattern. In the following description, the position (in the scanner coordinate system) of the i-th pattern of the test pattern is called “P(i)”, and the position (in the scanner coordinate system) of the j-th line of the standard pattern is called “K(j)”. Moreover, the interval (y direction interval) between the (j−1)-th line and the j-th line of the standard pattern is called “L”, and the interval (y direction interval) between the (j−1)-th line of the standard pattern and the i-th pattern of the test pattern is called “L(i)”.

First, the correction-value acquiring program calculates the position of each pattern using image data of an image within the range that is indicated by a dotted line, of the image of the test pattern shown in FIG. 12A. Here, the correction-value acquiring program calculates a centroid position of tone values of each pattern (see FIG. 12B) from the image data of the image within the above-described range indicated by the dotted line, and uses this centroid position as the position of each pattern.

Next, in calculation of the absolute position, the correction-value acquiring program calculates the ratio H of the interval L(i) to the interval L based on the following equation:

$$\begin{matrix}H = L ( i ) / L \\ = \{ P ( k ) - K ( j - 1 ) \} / \{ K ( j ) - K ( j - 1 ) \}\end{matrix}$$

Incidentally, the standard pattern on the actual standard sheet SS has uniform intervals, and therefore, the position of an arbitrary line of the standard pattern can be calculated when the absolute position of the first line of the standard pattern is taken as zero. For example, the absolute position of the second line of the standard pattern is 1/36 inch. Accordingly, when the absolute position of the j-th line of the standard pattern is given as “J(j)” and the absolute position of the i-th pattern of the test pattern is given as “R(i)”, R(i) can be calculated by the following equation:

R(i)={J(j)−J(j−1)}×H+J(j−1)

In the following, a procedure to calculate the absolute position of each pattern will be described using, as a specific example, the case of calculating the absolute position R(1) of the first pattern in the test pattern. First, as shown in FIG. 13, the correction-value acquiring program detects that the pattern P(1) is positioned between the second line and the third line of the standard pattern. Next, the correction-value acquiring program obtains that the ratio H is 0.40143008 (=(373.7686667−309.613250)/(469.430413−309.613250)). Finally, the absolute position R(1) of the first pattern is obtained to be 0.98878678 mm (=0.038928613 inches={ 1/36 inch}×0.40143008+ 1/36 inch) from the positional relationship shown in FIG. 14.

### Acquisition of the Correction Values

After calculating the absolute position of each pattern in the above-described manner, the correction-value acquiring program obtains a correction value for each transport operation during test pattern printing (S134).

More specifically, a correction value C(i) is obtained for a transport operation that is carried out between pass i and pass i+1, of passes 1 to m−1 during test pattern printing. The correction value C(i) is a value calculated by subtracting “R(i+1)−R(i)” from “3.18 mm” (⅛ inch). In other words, the correction value C(i) is the difference between the theoretical and actual pattern intervals between a pattern P(i) and a pattern P(i+1). For example, the correction value C(1) of the transport operation that is carried out between pass 1 and pass 2 is 3.18 mm−{R(2)−R(1)}.

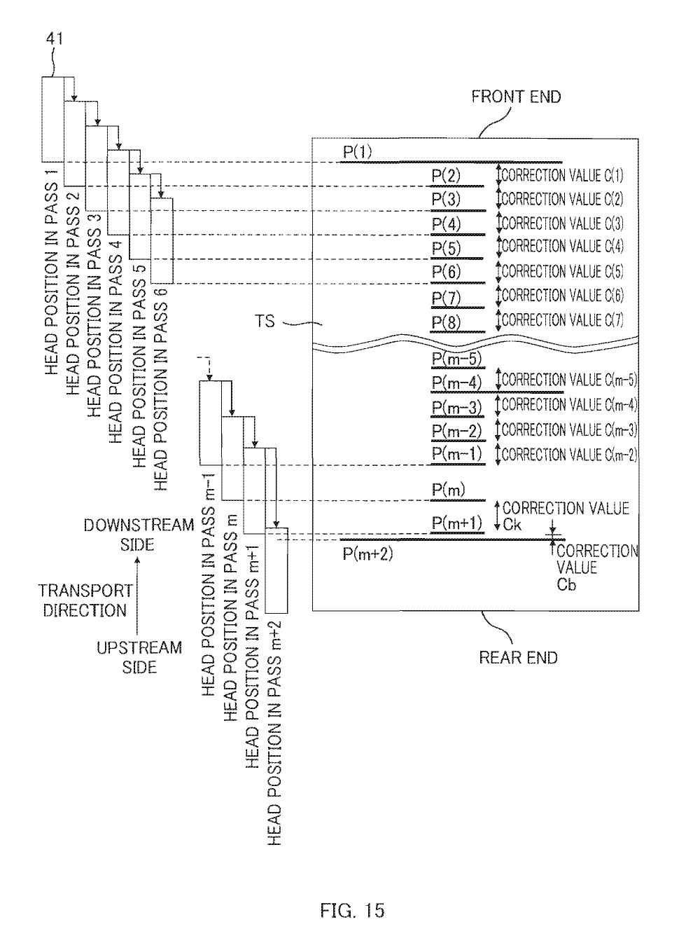

In this manner, as shown in FIG. 15, correction values C(1) to C(m−2) are obtained for respective transport operations. FIG. 15 is an explanatory diagram of correction values that are obtained for respective transport operations.

Similarly, a correction value Ck is obtained for the transport operation that is carried out between pass m and pass m+1. The correction value Ck is a value calculated by subtracting “R(m+1)−R(m)” from “4.23 mm” (⅙ inch). In other words, the correction value Ck is the difference between the theoretical and actual pattern intervals between the pattern P(m) and the pattern P(m+1).

Moreover, a correction value Cb is obtained for the transport operation that is carried out between pass m+1 and pass m+2. The correction value Cb is a value calculated by subtracting “R(m+2)−R(m+1)” from the theoretical interval between the pattern P(m+1) and the pattern P(m+2), “0.847 mm” ( 3/90 inches). In other words, the correction value Cb is the difference between the theoretical and actual pattern intervals between the pattern P(m+1) and the pattern P(m+2).

As described above, the correction values can be obtained in a simple and appropriate manner by measuring a pattern interval and obtaining the difference between the theoretical value and the actual value of this pattern interval.

### Averaging of Correction Values

Incidentally, there is possibility that the rotation position of the paper-feed roller 23a at the start of each transport operation varies from one printing process to another. As a result, the pattern intervals in the patterns P(1) to P(m−1) are affected not only by the DC component transport error but also by the AC component transport error. However, with respect to the correction values C(1) to C(m−2) that are obtained by the above-described method, the AC component transport error is not taken into consideration. Thus, when these correction values C(1) to C(m−2) are applied as they are, the transport errors are in some cases increased conversely.

Accordingly, in the present embodiment, the correction values C(1) to C(m−2) are averaged by the following equation (S135) in order to prevent the influence of the AC component transport error from being easily reflected. Note that a correction value obtained by averaging is called an average correction value Ct.

Ct(i)={C(i−3)+C(i−2)+C(i−1)+C(i)+C(i+1)+C(i+2)+C(i+3)+C(i+4)}/8

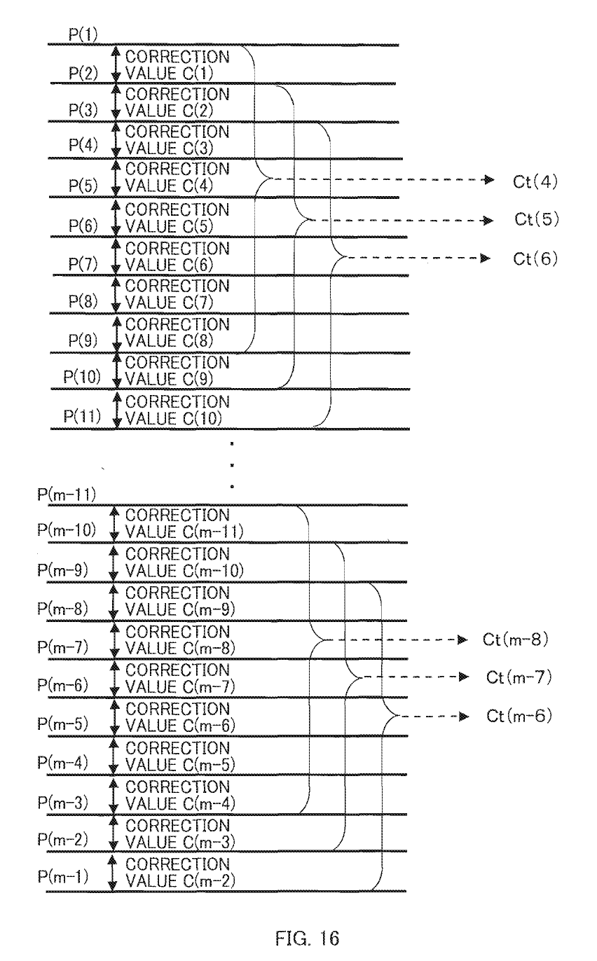

In the following, the relationship between each pattern in the test pattern and the average correction value Ct will be described using FIG. 16. FIG. 16 is an explanatory diagram of this relationship.

As shown in FIG. 16, an average correction value Ct(i) is obtained based on pattern intervals in patterns P(i−3) to P(i+4). For example, the average correction value Ct(4) is a value (an average value of the correction values C(1) to C(8)) calculated by dividing the sum total of the correction values C(1) to C(8) by 8. The thus obtained average correction value Ct(i) is associated with the transport operation between pass i and pass i+1 in test pattern printing. In other words, the average correction value Ct(i) is calculated for a movement range (theoretical value) of the test sheet TS in the transport operation between pass i and pass i+1 during test pattern printing.

Note that in the case where i is 3 or less in calculation of the average correction value Ct(i), the average correction value Ct(i) is a value calculated by dividing the sum total of C(1) to C(8) by 8. Moreover, in the case where i is m−5 or more in calculation of the average correction value Ct(i), the average correction value Ct(i) is a value calculated by dividing the sum total of C(m−9) to C(m−2) by 8. Furthermore, the average correction value Ct(m−1) associated with the transport operation (the m-th transport operation) between pass m−1 and pass m is a value calculated by multiplying the average correction value Ct(m−2) of the transport operation (the (m−1)-th transport operation) between pass m−2 and pass m−1 by a ratio a/b of a transport direction length a of the movement range in the m-th transport operation to a transport direction length b of the movement range in the (m−1)-th transport operation.

Incidentally, since the patterns P(1) to P(m−1) are formed at about every ⅛ inch, the average correction value Ct is calculated at every ⅛ inch. In other words, since the pattern interval is set to ⅛ of the circumference (one inch) of the paper-feed roller 23a in test pattern printing, the application range of each average correction value Ct(i) can be ⅛ inch regardless of the fact that each average correction value Ct(i) is a value corresponding to the interval between two lines that should theoretically be one inch away from each other. As a result, it is possible to suppress the influence of the AC component transport error, and at the same time, to achieve fine correction on the DC component transport error.

Moreover, the correction value Ck is a correction value for correcting the transport error due to kicking-off and is unsuitable for averaging together with the other correction values. Therefore, in the present embodiment, the correction value Ck is not averaged. Moreover, the correction value Cb is also unsuitable for averaging together with the other correction values, and so the correction value Cb is not averaged.

### Storing of Correction Values

Next, the step (S104) in which the correction-value acquiring program stores the correction values in the memory 63 of the printer 1 will be described.

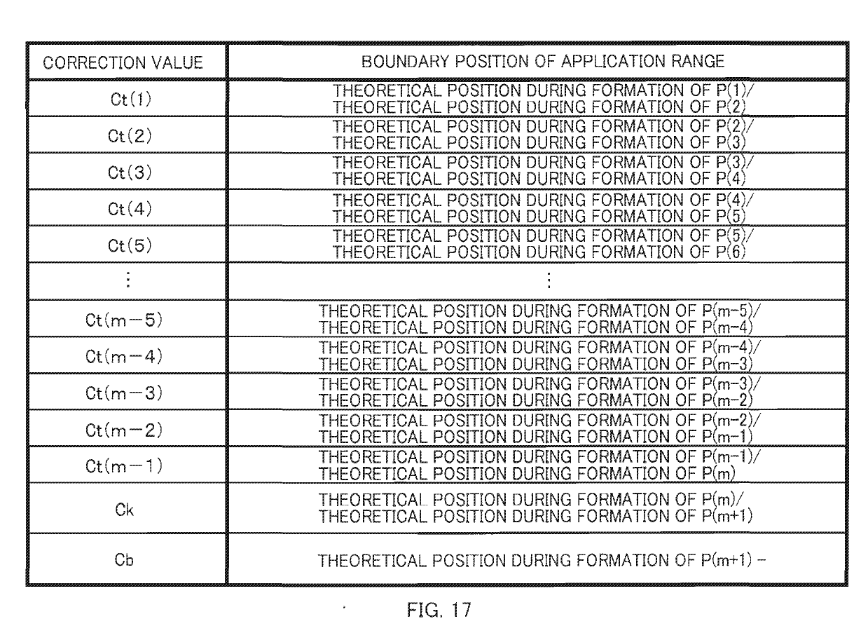

The correction values that are stored in the memory 63 are the average correction values Ct(i), the correction value Ck, and the correction value Cb. In addition, boundary position information for indicating the range (application range) to which each correction value is applied is also stored in the memory 63. The boundary position information is information that indicates boundary positions of the application range of each correction value on both of the upstream side in the transport direction and the downstream side in the transport direction. The correction values and the boundary position information are stored in the form of a table as shown in FIG. 17. FIG. 17 is a diagram showing the correction values and the boundary position information stored in the memory 63. In other words, in the present embodiment, each correction value is stored in the memory 63 while being associated with the application range thereof. Note that the application range of each correction value is set by the correction-value acquiring program.

After storing of the correction values in the memory 63, the printer 1 is packed and shipped.

### Transport Operations in Regular Printing

Next, transport operations in printing (regular printing) under the user who purchased the printer will be described using FIGS. 18 and 19. FIG. 18 is a diagram showing information about the transport operations in regular printing. FIG. 19 is a diagram showing a manner in which regular printing is performed; the paper S on which an image is printed by regular printing is shown on the right side of the figure, and rectangles on the left side of the figure indicate the position (relative position with respect to the paper S) of the head 41 in each pass. In FIG. 19, as in the case of FIG. 8, the head 41 is illustrated as if moving with respect to the paper S, but in fact the paper S is intermittently transported in the transport direction. Moreover, a hatched region of the head 41 shown in the figure indicates a region in which nozzles that do not eject ink in each pass are lined up.

As described above, regular printing is performed by the controller 60 carrying out the transport operation and the dot formation operation repeatedly based on the print data sent from the computer 110 owned by the user. When carrying out each transport operation, the controller 60 reads information about the transport operations that has been stored in advance in the memory 63 and carries out each transport operation based on that information.

The information about the transport operations includes information about the theoretical position (hereinafter referred to as the theoretical position Q(i)) of the paper S in pass i, information about the theoretical value of the target transport amount (that is, the pre-correction target transport amount, hereinafter referred to as the target transport amount F(i)) for transporting the paper S in a transport operation between pass i−1 and pass i, and soon. As shown in FIG. 18, the foregoing information is stored in the memory 63 in the form of a table and is hereinafter referred to as the recorded information.

The recorded information will be described in greater detail with reference to FIGS. 18 and 19.

As shown in FIGS. 18 and 19, pass 1 to pass 4 correspond to passes during the aforementioned top-end printing. Similarly, pass 5 to pass n correspond to passes during normal printing, and pass n+1 to pass n+4 correspond to passes during bottom-end printing. Here, the theoretical position Q(i) in each pass in regular printing is different from the above-described theoretical position in each pass in test pattern printing. In other words, the target transport amount F(i) in each transport operation between passes during regular printing is different from the target transport amount in each transport operation between passes during test pattern printing. For example, the target transport amounts F(5) to F(n) in transport operations that are carried out between passes during normal printing are set to be longer than the target transport amounts (that is, ⅛ inch or ⅙ inch) in transport operations that are carried out between passes 1 to m during test pattern printing.

Moreover, in the recorded information, the theoretical position Q(1) in pass 1 is a theoretical position of the aforementioned print start position. That is to say, the target transport amount F(1) is a target transport amount for positioning the paper S that has been fed into the printer at the print start position in the initial transport operation. Note that the theoretical position Q(1) and the target transport amount F(1) in printing an image on the paper S up to its front and rear ends (so-called borderless printing) are different from those in printing an image on the paper S while creating margins from its front and rear ends to certain positions (so-called bordered printing). For this reason, different recorded information is prepared for borderless printing and bordered printing.

Moreover, in the present embodiment, as shown in FIG. 19, the theoretical position Q(n−1) in pass n−1 is positioned further upstream in the transport direction than the theoretical position during formation of the pattern P(m). On the other hand, the theoretical position Q(n) in pass n is positioned further downstream in the transport direction than the theoretical position during formation of the pattern P(m+1). That is to say, the movement range of the paper S in the transport operation between pass n−1 and pass n (hereinafter referred to as the n-th transport operation) straddles the above-described kicking-off occurring range. Therefore, the n-th transport operation is set as a transport operation that transports the paper S in such a manner theoretically as the paper S passes through the kicking-off occurring position.

Furthermore, the n-th transport operation is set in such a manner that, when the n-th transport operation is carried out, the midpoint between the theoretical position Q(n−1) and the theoretical position Q(i) coincides with the midpoint between the theoretical position during formation of the pattern P(m) and the theoretical position during formation of the pattern P(m+1), as shown in FIG. 19.

In the present embodiment, the setting of the n-th transport operation as described above is performed by setting the theoretical position Q(1) in pass 1, that is, the print start position to an appropriate position. In other words, the print start position is set in such a manner that the paper S passes through the kicking-off occurring position in the n-th transport operation and the midpoint between the theoretical position Q(n−1) and the theoretical position Q(i) coincides with the midpoint between the respective theoretical positions during formation of the pattern P(m) and the pattern P(m+1). The reason why the setting of the n-th transport operation can be performed by setting the print start position in this manner is that when the print start position is set, the theoretical position in each pass (more precisely, the theoretical position in passes after pass 1) is set in accordance with the print start position. Note that simultaneously with the setting of the theoretical position Q(1), the target transport amount F(1) for positioning the paper S at the print start position in the initial transport operation is also set to an appropriate transport amount.

Note that in the present embodiment, the setting of the n-th transport operation is performed by setting the print start position, as described above. However, this is not a limitation, and the setting of the n-th transport operation can also be performed, for example, by setting the theoretical position Q(i) in an arbitrary pass of passes 2 to n−1 to an appropriate position. The present embodiment is, however, more advantageous in that the setting of the print start position is simpler in terms of control.

Then, in regular printing, the controller 60 reads the correction values stored in the memory 63 when carrying out each transport operation, corrects the target transport amount F(i) using the correction values, and performs the transport operation based on the corrected target transport amount (the post-correction target transport amount).

### Application Pattern of Correction Values

Next, a pattern for applying the correction values to each transport operation, that is, a pattern for correcting the target transport amount F(i) using the correction values will be described.

In the case where an application range associated with a certain correction value and a movement range of the paper S in a certain transport operation overlap in the transport direction, the certain correction value is applied to the certain transport operation. In other words, the certain correction value is applied to a transport operation that transports the paper S from a position located further upstream than the downstream-side boundary position of the application range to a position located further downstream than the upstream-side boundary position of the application range. In the following, the correction value application pattern will be described for each type of the correction values (the average correction value Ct, the correction value Ck, and the correction value Cb).

### Correction Using Average Correction Value Ct

First, correction using the average correction value Ct(i) will be specifically described.

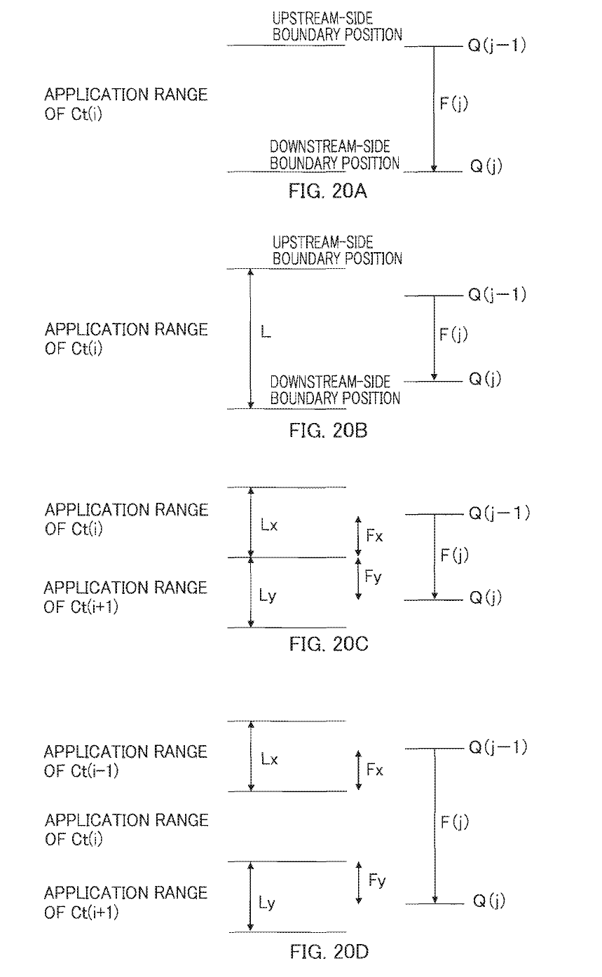

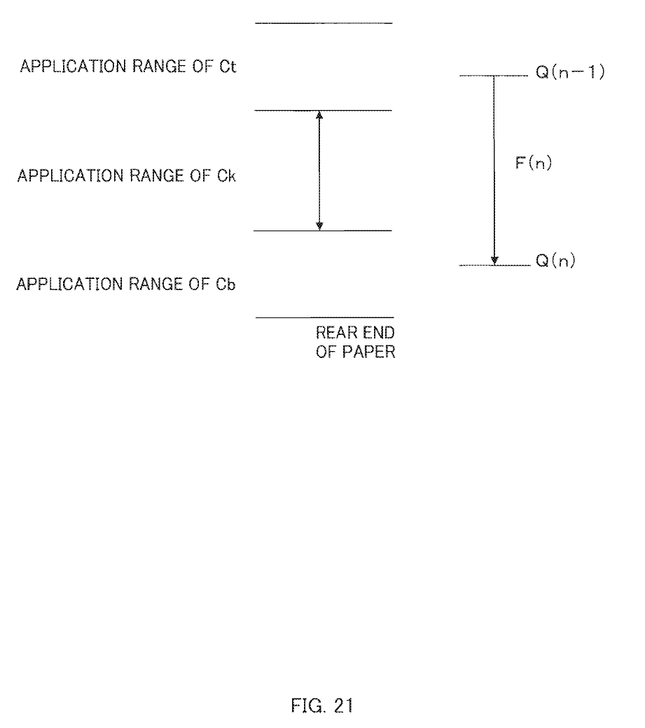

As shown in FIG. 17, the application range of the average correction value Ct(i) corresponds to a range from the theoretical position during formation of a pattern P(i) to the theoretical position during formation of a pattern P(i+1) in test pattern printing. For example, the application range of the average correction value Ct(3) corresponds to a range from the theoretical position during formation of the pattern P(3) to the theoretical position during formation of the pattern P(4). Then, in the case where the movement range of the paper S in the transport operation (the j-th transport operation) between pass j−1 and pass j during regular printing overlaps with the application range of the average correction value Ct(i) in the transport direction, the target transport amount F(j) for transporting the paper S in the j-th transport operation is corrected using the average correction value Ct(i). In the following, application of the average correction value Ct(i) will be specifically described with reference to FIGS. 20A to 20D. FIGS. 20A to 20D are explanatory diagrams of application patterns of the average correction value Ct(i).

A first example of the application patterns of the average correction value Ct(i) is a case where, as shown in FIG. 20A, the theoretical position Q(j−1) in pass j−1 coincides with the upstream-side boundary position of the application range of the correction value Ct(i) and the theoretical position Q(j) in pass j coincides with the downstream-side boundary position of this application range. In this case, the controller 60 corrects the target transport amount F(j) for transporting the paper S in the j-th transport operation using the average correction value Ct(i).

A second example of the application patterns is a case where, as shown in FIG. 20B, both of the theoretical position Q(j−1) and the theoretical position Q(j) are within the application range of the correction value Ct(i). In this case, the controller 60 uses, as a correction value, a value calculated by multiplying Ct(i) by the ratio F(j)/L of the target transport amount F(j) to the length L of the application range of the average correction value Ct(i) in the transport direction. Then, the controller 60 corrects the target transport amount F(j) using this correction value.

A third example of the application patterns is a case where, as shown in FIG. 20C, the theoretical position Q(j−1) is within the application range of the average correction value Ct(i) and the theoretical position Q(j) is within the application range of an average correction value Ct(i+1). This is the case where the movement range of the paper S in the j-th transport operation extends over the application ranges of the two average correction values Ct(i) and Ct(i+1). Here, a transport amount of the target transport amount F(j) within the application range of the average correction value Ct(i) is given as Fx, and a transport amount of the target transport amount F(j) within the application range of the average correction value Ct(i+1) is given as Fy. Moreover, the length of the application range of the average correction value Ct(i) in the transport direction is given as Lx, and the length of the application range of the average correction value Ct(i+1) in the transport direction is given as Ly. In this case, the controller 60 uses, as a correction value, the sum of a value calculated by multiplying Ct(i) by Fx/Lx and a value calculated by multiplying Ct(i+1) by Fy/Ly. Then, the controller 60 corrects the target transport amount F(j) using this correction value.

A fourth example of the application patterns is a case where, as shown in FIG. 20D, the theoretical position Q(j−1) is within the application range of an average correction value Ct(i−1) and the theoretical position Q(j) in pass j is within the application range of the average correction value Ct(i+1). This is the case where the movement range of the paper S in the j-th transport operation extends over the application ranges of the three average correction values Ct(i−1), Ct(i), and Ct(i+1). Here, a transport amount of the target transport amount F(j) within the application range of the average correction value Ct(i−1) is given as Fx, and a transport amount of the target transport amount F(j) within the application range of the average correction value Ct(i+1) is given as Fy. Moreover, the length of the application range of the average correction value Ct(i−1) in the transport direction is given as Lx, and the length of the application range of the average correction value Ct(i+1) in the transport direction is given as Ly. In this case, the controller 60 uses, as a correction value, the sum of a value calculated by multiplying Ct(i−1) by Fx/Lx, Ct(i), and a value calculated by multiplying Ct(i+1) by Fy/Ly. Then, the controller 60 corrects the target transport amount F(j) using this correction value.

As described above, the controller 60 corrects the target transport amount F(j) using the average correction value Ct(i) and carries out the j-th transport operation based on the corrected target transport amount (that is, the post-correction target transport amount). Thus, the above-described DC component transport error is corrected. Furthermore, since the application range of each average correction value Ct(i) is set at every ⅛ inch, it is possible to accurately correct the DC component transport error, which varies depending on the relative position of the paper S and the head 41.

### Correction Using Correction Value Ck

Next, correction using the correction value Ck will be described.

As shown in FIG. 17, the application range of the correction value Ck is a range from the theoretical position during formation of the pattern P(m) to the theoretical position during formation of the pattern P(m+1), that is, the kicking-off occurring range. In other words, in the present embodiment, the application range of the correction value Ck is associated with the kicking-off occurring range.

Here, the upstream-side boundary position (that is, the theoretical position during formation of the pattern P(m)) of the application range of the correction value Ck is defined as a first position, and the downstream-side boundary position (that is, the theoretical position during formation of the pattern P(m+1)) of this application range is defined to as a second position. In other words, the first position is a position of the paper S in the transport direction when the paper S is sandwiched between the upstream-side transport rollers 23 and between the downstream-side transport rollers 25. On the other hand, the second position is a position of the paper S in the transport direction when the paper S is sandwiched between only the downstream-side transport rollers 25 of the upstream-side and downstream-side transport rollers.

Then, in the case where the movement range of the paper S in a certain transport operation during regular printing and the application range of the correction value Ck overlap, the correction value Ck is applied to the certain transport operation. At this time, the certain transport operation is a transport operation that transports the paper S from a position upstream from the second position in the transport direction to a position downstream from the first position in the transport direction. Hereinafter, the position upstream from the second position is referred to as a third position, and the position downstream from the first position and the third position is referred to as a fourth position.

In the present embodiment, as shown in FIG. 19, the movement range in the transport operation (the n-th transport operation) between pass n−1 and pass n during regular printing overlaps with the application range of the correction value Ck. In other words, the n-th transport operation is a transport operation that transports the paper S from the third position to the fourth position, and the theoretical position Q(n−1) in pass n−1 corresponds to the third position and the theoretical position Q(n) in pass n corresponds to the fourth position. Furthermore, as already described above, the theoretical position Q(n−1) is positioned upstream from the theoretical position (the first position) during formation of the pattern P(m), and the theoretical position Q(n) is positioned downstream from the theoretical position (the second position) during formation of the pattern P(m+1). Therefore, the n-th transport operation is a transport operation that transports the paper S from a position upstream from the first position in the transport direction to a position downstream from the second position in the transport direction.

The correction value Ck is applied to an n-th transport operation as described above. In the present embodiment, only the movement range in the n-th transport operation overlaps with the application range of the correction value Ck, so that the transport operation to which the correction value Ck is applied is limited to the n-th transport operation.

Then, as shown in FIG. 21, the application pattern of the correction value Ck is similar to the pattern of the fourth example among the above-described application patterns of the average correction value Ct(i). FIG. 21 is an explanatory diagram of the application pattern of the correction value Ck. Specifically, the ideal position Q(n−1) in pass n−1 is within the application range of an average correction value Ct(i) and the ideal position Q(n) in pass n is within the application range of the correction value Cb, and therefore, the controller 60 uses, as a correction value, a value calculated using Ct(i), Ck, and Cb. Then the controller 60 corrects the target transport amount F(n) in the n-th transport operation using this correction value.

In this manner, the transport error due to kicking-off is corrected by the controller 60 carrying out the n-th transport operation based on the post-correction target transport amount that has been corrected using the correction value Ck (more correctly the correction value calculated using Ct(i), Ck, and Cb). As a result, the paper S can be accurately transported from the theoretical position Q(n−1) in pass n−1 to the theoretical position Q(n) in pass n.

### Correction Using Correction Value Cb

Next, correction using the correction value Cb will be described.

As shown in FIG. 17, the application range of the correction value Cb is a range during transport of the paper S downstream in the transport direction from the theoretical position during formation of the pattern P(m+1). In other words, the correction value Cb is applied to transport operations that are carried out while the paper S is sandwiched between only the downstream-side transport rollers 25 in regular printing. Note that in regular printing, the transport operations that are carried out while the paper S is sandwiched between only the downstream-side transport rollers 25 are n-th to (n+4)-th transport operations.

Then, when the controller 60 carries out the (n+1)-th to (n+4)-th transport operations, the controller 60 corrects the target transport amounts F(n+1) to F(n+4) using the correction value Cb and carries out the transport operations based on the target transport amounts after correction that have been corrected. In this manner, the transport errors in the (n+1)-th to (n+4)-th transport operations can be accurately corrected by the controller 60 carrying out the (n+1)-th to (n+4)-th transport operations based on the corrected transport amounts that have been corrected using the correction value Cb.

Note that the n-th transport operation is as described above, and so the description thereof will be omitted.

### Effectiveness of Printer of Present Embodiment

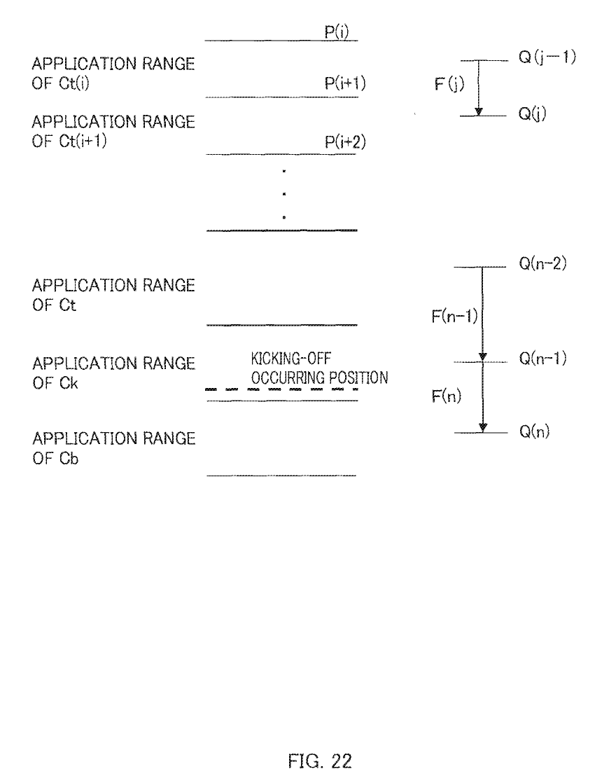

With the configuration according to the foregoing embodiment, the transport operation for transporting the paper S can be properly carried out in the printer 1 of the present embodiment. This effect will be described below using FIG. 22. FIG. 22 is a diagram showing a comparative example for explaining the effectiveness of the printer 1 of the present embodiment.

As described above, the controller 60 of the printer 1 applies each correction value in accordance with the application range thereof. That is to say, as described above, in the case where the movement range of the paper S in a certain transport operation and the application range of a certain correction value overlap, the controller 60 applies the certain correction value to the certain transport operation.

Here, in the case where the correction value is an average correction value Ct(i), when the application range of the average correction value Ct(i) overlaps with the movement range in, for example, a j-th transport operation, the controller 60 applies the average correction value Ct(i) to the j-th transport operation. In this case, the controller 60 applies the average correction value Ct(i) to the j-th transport operation based on an application pattern corresponding to the movement range, of the above-described application patterns of the average correction value Ct(i). More specifically, when the movement range in the j-th transport operation is a movement range as shown in FIG. 22, the third example of the application patterns is employed.

On the other hand, in the case where the correction value is the correction value Ck, the correction value Ck is applied when a transport operation is carried out in such a manner as the paper S is transported from a position (the third position) upstream in the transport direction from the downstream-side boundary position (the second position) of the application range of the correction value Ck to a position (the fourth position) downstream in the transport direction from the upstream-side boundary position (the first position) of this application range. That is to say, the application range of the correction value Ck and the movement range of the paper S in the transport operation that transports the paper S from the third position to the fourth position overlap. Then, for example, in the case where the movement range in an n-th transport operation and the application range of the correction value Ck overlap, the target transport amount F(n) in the n-th transport operation is corrected using the correction value Ck, and consequently, even when kicking-off occurs, the transport error due to this kicking-off is properly corrected.

Incidentally, in order for the correction value Ck to properly exert the correction effect, kicking-off has to occur in a transport operation to which the correction value Ck is applied. In other words, the correction value Ck should essentially be applied to a transport operation that transports the paper S in such a manner as the paper S passes through the kicking-off occurring position. However, the respective movement ranges in a plurality of transport operations may overlap with the application range of the correction value Ck. For example, this is the case where, as shown in FIG. 22, both of the movement range in an (n−1)-th transport operation and the movement range in the n-th transport operation overlap with the application range of the correction value Ck. In such a case, the correction value Ck is applied not only to the n-th transport operation that transports the paper S in such a manner as the paper S passes through the kicking-off occurring position (indicated by dashed line in FIG. 22) but also to the (n−1)-th transport operation. That is to say, as in the case shown in FIG. 22, when a plurality of transport operations are carried out in order to pass the paper S through the application range of the correction value Ck (that is, the kicking-off occurring range), the correction value Ck is applied to the transport operation (the (n−1)-th transport operation in the case shown in FIG. 22) to which the correction value Ck should not be applied. Then, when the correction value Ck is applied to a transport operation to which the correction value Ck should not be applied, the target transport amount in this transport operation is excessively corrected, and consequently, it is conversely difficult to properly transport the paper S. The reason for this is that the transport error due to kicking-off is larger than the other transport errors (e.g., the DC component transport error) and the correction value Ck, which corresponds to the transport error due to kicking-off, is also large compared with the other correction values (e.g., the average correction value Ct(i)).

In contrast, in the present embodiment, when a transport operation is carried out in such a manner as to transport the paper S from the third position to the fourth position, the transport operation (the n-th transport operation during regular printing in the present embodiment) is carried out in such a manner as to transport the paper S from a position upstream from the first position to a position downstream from the second position. That is to say, in the present embodiment, the movement range of the paper S in the n-th transport operation is set to a range that straddles the application range of the correction value Ck. Thus, the paper S passes through this application range, that is, the kicking-off occurring range by carrying out a single transport operation (carrying out the n-th transport operation). Therefore, in the present embodiment, the transport operation to which the correction value Ck is applied is limited only to the n-th transport operation during which kicking-off occurs, that is, the transport operation to which the correction value Ck should be applied. As a result, in the present embodiment, the correction value Ck can be prevented from being applied to a transport operation to which the correction value Ck should not be applied. This enables the correction value Ck to properly exert the correction effect, and consequently, the transport operation that transports the paper S can be properly carried out.

Furthermore, the n-th transport operation is set so that the central position (that is, the midpoint between the third position and the fourth position), in the transport direction, of the movement range of the paper S in the n-th transport operation coincides with the central position (that is, the midpoint between the first position and the second position) of the kicking-off occurring range (see FIG. 19). Thus, even when the movement range in the n-th transport operation is more or less displaced from the theoretical movement range under the influence of, for example, malfunction of the apparatus, the paper S passes through the central position of the kicking-off occurring range in the n-th transport operation. Moreover, kicking-off is highly likely to occur at this central position of the kicking-off occurring range. Therefore, by the above-described setting, it is possible to cause kicking-off to occur during the n-th transport operation even in the case where the movement range is more or less displaced.

### Other Embodiments

Although the liquid ejecting apparatus, a specific example of which is the printer 1, was mainly described in the foregoing embodiment, the method for moving a medium was also disclosed in the foregoing description. Moreover, the foregoing embodiment is merely for facilitating the understanding of the invention, but is not meant to be interpreted in a manner limiting the scope of the invention. The invention can of course be altered and improved without departing from the gist thereof and includes functional equivalents.

What is claimed is:

1. A liquid ejecting apparatus comprising:
an upstream-side transport roller and a downstream-side transport roller that are respectively provided on an upstream side and a downstream side in a transport direction of a medium, and that transport the medium by rotating while the medium being sandwiched therewith;
an ejecting section that ejects liquid to the medium; and
a controller
that carries out repeatedly, in an alternating manner, a transport operation of the medium by at least either one of the upstream-side transport roller and the downstream-side transport roller and an ejection operation of the liquid by the ejecting section;
that stores in advance a correction value for correcting a pre-correction target transport amount for transporting the medium, the correction value being associated with a range from a first position where the medium is located in the transport direction when the medium is sandwiched with both of the upstream-side transport roller and the downstream-side transport roller to a second position where the medium is located in the transport direction when the medium is sandwiched with only the downstream-side transport roller of both transport rollers;
that carries out the transport operation based on a post-correction target transport amount in the case where the controller carries out the transport operation in such a manner as the medium is transported from a third position upstream in the transport direction from the second position to a fourth position downstream in the transport direction from the first position and the third position, the post-correction target transport amount being obtained by correcting, using the correction value, the pre-correction target transport amount for transporting the medium from the third position to the fourth position; and
that carries out the transport operation in such a manner as the medium is transported from a position upstream in the transport direction from the first position to a position downstream in the transport direction from the second position in the case where the transport operation is carried out in such a manner as the medium is transported from the third position to the fourth position.

2. A liquid ejecting apparatus according to claim 1, wherein
the liquid ejecting apparatus is a printing apparatus for printing an image on the medium;
the controller
stores in advance a print start position that is set in such a manner as the third position is upstream in the transport direction from the first position and the fourth position is downstream in the transport direction from the second position; and
before the start of the ejection operation by the ejecting section, moves the medium to the print start position in the transport direction by making the transport rollers carry out the transport operation.

3. A liquid ejecting apparatus according to claim 1, wherein
in carrying out the transport operation in such a manner as the medium is transported from the third position to the fourth position downstream in the transport direction from the third position,
the controller carries out the transport operation in such a manner as the medium is transported from a position upstream in the transport direction from the first position to a position downstream in the transport direction from the second position and a midpoint between the third position and the fourth position coincides with a midpoint between the first position and the second position.

4. A liquid ejecting apparatus according to claim 1, wherein
the controller stores in advance the correction value that is obtained based on formation positions of a first pattern and a second pattern on the medium, the first pattern being formed by carrying out the ejection operation when the medium is sandwiched with both transport rollers and the second pattern being formed by carrying out the ejection operation when the medium is sandwiched with only the downstream-side transport roller of both transport rollers.

5. A method for moving a medium by repeatedly carrying out a transport operation by at least either one of an upstream-side transport roller and a downstream-side transport roller, the method comprising:
storing a correction value for correcting a pre-correction target transport amount for transporting the medium, the correction value being associated with a range from a first position where the medium is located in a transport direction when the medium is sandwiched with both of the upstream-side transport roller and the downstream-side transport roller to a second position where the medium is located in the transport direction when the medium is sandwiched with only the downstream-side transport roller of both transport rollers; and
in the case of carrying out the transport operation in such a manner as the medium is transported from a third position upstream in the transport direction from the second position to a fourth position downstream in the transport direction from the first position and the third position,
carrying out the transport operation based on a post-correction target transport amount in such a manner as the medium is transported from a position upstream in the transport direction from the first position to a position downstream in the transport direction from the second position, the post-correction target transport amount being obtained by correcting, using the correction value, the pre-correction target transport amount for transporting the medium from the third position to the fourth position.
